(19) United States
(12) Patent Application Publication
(10) Pub. No.: US 2025/0334551 A1
(43) Pub. Date: Oct. 30, 2025

(54) RAILWAY VEHICLE WHEEL PRECISION INSPECTION DEVICE

(71) Applicant: KOREA RAILROAD RESEARCH INSTITUTE, Uiwang-si (KR)

(72) Inventors: Min Soo KIM, Uiwang-si (KR); Seok Jin KWON, Uiwang-si (KR)

(21) Appl. No.: 18/922,017

(22) Filed: Oct. 21, 2024

(30) Foreign Application Priority Data
Apr. 30, 2024 (KR) 10-2024-0058150

(51) Int. Cl. G01N 29/07; G01N 29/27; G01N 29/28

(52) U.S. Cl. CPC G01N 29/07; G01N 29/27; G01N 29/28; G01N 2291/011; G01N 2291/0234; G01N 2291/0289; G01N 2291/106; G01N 2291/2696

(57) ABSTRACT

A railway vehicle wheel defect detection precision inspection device includes a lower frame module, an upper frame module, a fixing module, a rotational module, a first inspection module, and a second inspection module. The lower frame module forms a lower space. The upper frame module has a structure that is movable in a horizontal direction and thus is coupled to the lower frame module to form an upper space. The fixing module is located in the lower space to fix a wheel. The rotational module rotates the wheel on a side portion of the fixing module. A pair of first inspection modules each has a structure surrounding an outer surface of a rim part of the wheel in the upper space, are disposed at symmetrical locations with respect to a wheel center point, and perform defect inspection on a web part of the wheel using ultrasonic waves. The second inspection module is disposed at a location in contact with a side surface of the rim part on a central upper end portion of the wheel in the upper space and performs defect inspection on the rim part of the wheel using ultrasonic waves. A third inspection module performs defect inspection by radiating a laser beam on a surface of the rim part of the wheel in contact with a rail in a side space of the inspection device and receiving the reflected laser beam.

### CROSS-REFERENCE TO RELATED APPLICATION

This application claims priority to and the benefit of Korean Patent Application No. 10-2024-0058150, filed on Apr. 30, 2024, the disclosure of which is incorporated herein by reference in its entirety.

### BACKGROUND

### 1. Field of the Invention

The present invention relates to an inspection device for railway vehicle wheel defect detection, and more specifically, to an inspection device for railway vehicle wheel defect detection, which more accurately and efficiently detects defects of a rim part and a web part having any of various specifications of the wheel of the railway vehicle using contact-type ultrasonic waves and non-contact-type lasers regardless of the size of the wheel.

### 2. Discussion of Related Art

It is important to detect defects of wheels of a railway vehicle in inspecting current states of the wheels and evaluating durability and future safety, and as a result, the defect detection is required for safe operations of railway vehicles. Therefore, many techniques for detecting defects of wheels are being developed. For example, Korean Patent Application Laid-Open No. 10-2015-0049398 discloses a technique for performing inspection using ultrasonic waves while rotating a wheel in detecting defects of wheels of a railway vehicle. In addition, Korean Patent Application Laid-Open No. 10-2006-0008580 discloses a technique for detecting defects of tires using non-contact laser-induced ultrasonic waves, and Japanese Patent No. 5912992 discloses a technique for inspecting a defect situation inside a tire by capturing images of outer circumferential surfaces of tires.

As described above, although many techniques for detecting defects of wheels of railway vehicles or tires of vehicles using ultrasonic waves, imaging images, etc., are being developed, a single device for identifying and detecting defects of a rim part and a web part of a wheel of a railway vehicle has not been developed yet, and in particular, only fragmentary techniques have been recently applied in detecting defects of wheels of a high-speed railway vehicle.

For wheels of a high-speed railway vehicle, since defect inspection is performed on only a rim part of a tread of the wheel and such defect inspection is also performed only by a rail embedded method or a method of installing an inspection device in a pit in a vehicle base when the vehicle enters and exits, not only there is a limitation in inspection, but also there is a problem that it is difficult to perform defect inspection on a web part. Therefore, there is a limitation in that the wheels cannot be inspected more accurately.

### RELATED ART DOCUMENTS

### Patent Documents

(Patent Document 1) Korean Patent Application Laid-Open No. 10-2015-0049398
(Patent Document 2) Korean Patent Application Laid-Open No. 10-2006-0008580
(Patent Document 3) Japanese Patent No. 5912992

### SUMMARY OF THE INVENTION

A railway vehicle wheel precision inspection device according to the technical spirit of the present invention is directed to providing an r inspection device for railway vehicle wheel defect detection, which more accurately and efficiently detects defects of a rim part and a web part of any of various specifications of a wheel of a railway vehicle using contact-type ultrasonic waves and non-contact-type lasers regardless of the size of the wheel.

Objects of the railway vehicle wheel precision inspection device according to the technical spirit of the present invention are not limited to the above-described object, and other objects that are not described will be able to be clearly understood by those skilled in the art from the following description.

According to an aspect of the present invention, there is provided an inspection device for railway vehicle wheel defect detection includes a lower frame module forming a lower space, an upper frame module coupled to the lower frame module and forming an upper space, a fixing module fixed to the lower frame module to fix a wheel, a rotational module configured to rotate the wheel at left and right side portions of the fixing module, a first inspection module fixed to the upper frame module and configured to perform defect inspection on a web part of the wheel, a second inspection module fixed to the upper frame module and configured to perform defect inspection on a rim part of the wheel, and a third inspection module fixed to the lower frame module and configured to perform defect inspection on a surface of the rim part of the wheel in contact with a rail, and detects the defect of the wheel.

In one embodiment of the present invention, the railway vehicle wheel precision inspection device may further include an LM guide on an upper end of the lower frame module to move the upper frame module in a first direction (X), wherein a mounting space is secured by moving the upper frame module in the first direction (X), and then the wheel is fixed to the fixing module.

In one embodiment of the present invention, the first and second inspection modules may be connected to the upper frame module, and locations of the first and second inspection modules may change according to a size of the wheel.

In one embodiment of the present invention, the upper frame module may include an upper horizontal frame extending in a horizontal direction, an additional horizontal frame which is fixed to an upper surface of the upper horizontal frame and on which the first inspection module is located by moving along a rail part in the horizontal direction, and a bent frame which is located on a central portion of the upper horizontal frame and on which the second inspection module is located by moving along a sliding groove in a vertical direction.

In one embodiment of the present invention, the fixing module may include a fixing unit including a pair of fixing plates coupled to a central portion of the wheel and configured to fix the central portion of the wheel such that the wheel is located in the lower space and the upper space, and a fixing extension frame configured to locate the fixing unit at a predetermined height at which the wheel is located.

In one embodiment of the present invention, each of a pair of rotational modules may include a roller in contact with the rim part of the wheel to rotate or support the wheel, a roller driving motor configured to provide a rotational driving force to the roller, a stage configured to hold the roller so that the roller rotates, and a transfer guide along which the stage moves in one direction.

In one embodiment of the present invention, the rotational module may further include a roller movement motor, a ball screw shaft rotated by the roller movement motor, and a pair of ball nuts rotated in opposite directions when the ball screw shaft rotates to transfer a pair of stages in opposite directions, and the pair of rotational modules may be transferred in a direction close to or away from each other by the rotation of the pair of ball nuts not only to rotate the wheel but also to move the wheel upward or downward to be fixedly located at the fixing module.

In one embodiment of the present invention, at least one first inspection module may be in contact with the rim part of the wheel to perform the defect inspection on the web part using ultrasonic waves.

In one embodiment of the present invention, one first inspection module performs the defect inspection using a pulse-echo inspection method when performing the defect inspection on the web part, and the pair of first inspection modules perform the defect inspection using a time of flight diffraction (TOFD) inspection method when performing the defect inspection on the web part.

In one embodiment of the present invention, when the pulse-echo inspection method is used, an ultrasonic inspection module may include a plurality of sensor modules disposed adjacent to each other on a tread of the wheel, and one of the sensor modules may be used as a pulser configured to generate ultrasonic waves and a receiver configured to receive ultrasonic waves reflected from a defect.

In one embodiment of the present invention, when the TOFD inspection method is used, a pair of ultrasonic inspection modules may be disposed to be spaced a predetermined distance from each other on a tread, a pair of sensor modules may be disposed, and any one of the pair of sensor modules may be used as a pulser configured to generate ultrasonic waves, and the other may be used as a receiver configured to receive ultrasonic waves reflected from the defect.

In one embodiment of the present invention, the first inspection module may include a first inspection body in contact with the rim part of the wheel and having a contact surface with the same curvature as the wheel, and a first inspection unit provided as a plurality of first inspection units arranged in the first inspection body to provide ultrasonic waves to the web part.

In one embodiment of the present invention, the first inspection module may further include a first vertical frame extending in a vertical direction so that a wedge comes in easy contact with the wheel, a first rotational frame having an end connected to the first inspection body and rotating about the first vertical frame to extend so that the first inspection body comes into contact with the rim part of the wheel, and a tilting stage configured to rotate the first inspection body about a hinge.

In one embodiment of the present invention, the first vertical frame may include a sliding groove and a fixing part formed in the sliding groove so that the first rotational frame is fixed above the sliding groove to vertically change a location thereof, and the first rotational frame may include a first pressing part having a predetermined elastic force and provide an external force for bringing the first inspection body into contact with the rim part of the wheel.

In one embodiment of the present invention, the second inspection module may include a plurality of sensor modules disposed adjacent to each other on a tread of the wheel and perform defect inspection on the rim part of the wheel using a pulse-echo inspection method in which one of the sensor modules is used as a pulser configured to generate ultrasonic waves and a receiver configured to receive ultrasonic waves reflected from a defect.

In one embodiment of the present invention, the second inspection module may include a second vertical frame extending in a vertical direction, a second sliding plate extending toward the rim part of the wheel in a direction perpendicular to the second vertical frame, a second inspection body attached to an end of the second sliding plate, and a second inspection unit provided as a plurality of second inspection units arranged in the second inspection body to provide ultrasonic waves to the rim part.

In one embodiment of the present invention, the second sliding plate may include a second pressing part having a predetermined elastic force and provide an external force for bringing the second inspection body into contact with the rim part of the wheel.

In one embodiment of the present invention, in an ultrasonic precision inspection module including a sensor module configured to perform defect inspection on the rim part or the web part of the wheel, the sensor module may include a wedge part configured to generate ultrasonic waves, a plunger part configured to press the wedge part to a tread above the wedge part, and a water provision part configured to provide water to the tread of the wheel through the wedge part.

In one embodiment of the present invention, the plunger part may include a fixing jig to which a bush located above the wedge part is fastened, a shaft in close contact with the wedge part through the fixing jig to which the bush is fastened, and a spring surrounding a lower end of the shaft between the bush and the wedge part to press an upper portion of the wedge part with an elastic force.

In one embodiment of the present invention, water provided to a lower flow path through the water provision part may form a water film between a lower surface portion of the wedge part and the tread of the wheel, and the ultrasonic precision inspection module may use the water as an ultrasonic contact medium so that the wedge part comes in easy contact with a surface of the wheel and ultrasonic beam transmissibility increases.

In one embodiment of the present invention, an ultrasonic inspection method using an ultrasonic inspection module, including analyzing stress on a wheel, selecting a predicted defect occurrence area based on a result of the stress analysis, determining a location and ultrasonic incidence angle of the sensor module in consideration of the selected predicted area, and analyzing a defect of the wheel using a pulse-echo inspection method or a time of flight diffraction (TOFD) inspection method may be applied to a railway vehicle wheel precision inspection device.

In one embodiment of the present invention, the analyzing of the stress in a web part of the wheel may include setting a weight on an axial center line of the wheel and deriving stress distribution occurring in the web part of the wheel, and selecting an area in which stress is concentrated as the predicted defect occurrence area of the web part of the wheel based on a result of the stress distribution.

In one embodiment of the present invention, the determining of the location and ultrasonic incidence angle of the sensor module may include, to allow the ultrasonic waves to pass through the predicted defect occurrence area, setting a location a tread of the sensor module, an incidence angle of the ultrasonic waves, and a frequency of the ultrasonic waves.

In one embodiment of the present invention, a total of four areas in which defect occurrences of the web part of the wheel are predicted may be selected, sensor modules configured to provide ultrasonic waves to each area are, with respect to a separation distance (X) from each area in a horizontal direction, a tilted angle (θ) with respect to a location of each area, and an angle (α) formed between a wedge part and each area, set according to conditions below: a first sensor module: X=168 mm, θ=21°, α=42.5°; a second sensor module: X=224 mm, θ=28°, α=36.6°; and a third sensor module: X=264 mm, θ=33°, α=31.25°; and a fourth sensor module: X=319 mm, θ=39°, α=26.2°, and the conditions may be applied to the ultrasonic inspection method of the web part of the wheel.

In one embodiment of the present invention, a total of four inspection areas (1′, 2′, 3′, 4′) in which defect occurrences are predicted in the analyzing of the stress on a rim part of the wheel may be selected, a total of three wedges providing ultrasonic waves to each area are, with respect to an inspection area, a distance downward in a third direction (Z) from an origin of the rim part to be located, and an incidence angle of a wedge, set according to conditions below: ultrasonic wedge (left): inspection area 1′, separation distance=28.3 mm, and incidence angle=23.1° (transverse wave upward); ultrasonic wedge (center): inspection area 2′, separation distance=15.3 mm, and incidence angle=0° (longitudinal wave perpendicular); and ultrasonic wedge (right): inspection areas 3′ and 4′, separation distances=15.3 mm, and incidence angles=27° (transverse wave downward) and 40° (longitudinal wave downward), and the conditions may be applied to the ultrasonic inspection method of the rim part of the wheel.

In one embodiment of the present invention, the third inspection module performs defect inspection on a tread surface of the rim part, which is a part of the wheel of a railway vehicle in contact with a rail after mounting a laser inspection module on a laser inspection module holder installed at a location at which a laser beam is radiated toward the wheel and composed of a plurality of laser sensors to receive a laser emitted from a light transmitting part in the laser sensor in a light receiving part at one side of a frame supporting an upper end portion of the lower frame module.

In one embodiment of the present invention, the laser inspection module holder may include a first stage along which the laser inspection module slides in a first direction (X), and a second stage along which the laser inspection module slides in a fourth direction (N-axis) linearly connecting the laser inspection module with a central axis of the wheel, and the first stage may serve to move in an inspection range of a wheel surface, and the second stage may serve to adjust the inspection range of the wheel surface by changing a distance between the laser sensor and the wheel surface.

In one embodiment of the present invention, the laser inspection module may acquire a profile of a surface of the rim part of the wheel by receiving reflected laser in the light receiving part when the laser radiated from the light transmitting part of the laser sensor is reflected from the wheel surface, and the laser inspection module holder may allow the laser inspection module to be mounted at a predetermined angle so that a laser beam is radiated to pass through a center of the wheel and incident in a normal direction of the rim part in order to secure reproducibility of inspection on acquisition of the profile of the surface of the rim part.

### BRIEF DESCRIPTION OF THE DRAWINGS

A brief description of each drawing will be made for better understanding for the accompanying drawings cited in the present specification.

FIG. 1 is a front perspective view of a railway vehicle wheel precision inspection device according to one embodiment of the present invention.

FIG. 2 is a rear perspective view of the railway vehicle wheel precision inspection device according to one embodiment of the present invention.

FIG. 3 shows a sliding movement structure of an upper frame module in a first direction (X-axis direction) according to one embodiment of the present invention.

FIG. 4 shows a fixing module and a fixing unit that fix the center of a wheel according to one embodiment of the present invention.

FIG. 5 shows a pair of rotational modules for rotating a wheel and an operation of adjusting a location of the wheel in a third direction while the rotational modules move in a second direction (Y-axis direction) according to one embodiment of the present invention.

FIG. 6 shows a state in which a first inspection body according to one embodiment of the present invention is mounted on an upper frame module, wherein the first inspection body may slide in the second direction (Y-axis direction) and a third direction (Z-axis direction), may rotate about an axis in the first direction (X-axis direction), and may be tilted by a tilting stage to be in easy contact with a rim part of the wheel.

FIG. 7 shows a first inspection module in detail according to one embodiment of the present invention.

FIG. 8 shows a state in which a second inspection body according to one embodiment of the present invention is mounted on the upper frame module through a bent frame, wherein the second inspection body may slide in the first direction (X-axis direction) and the third direction (Z-axis direction).

FIG. 9 shows a configuration of an ultrasonic sensor module used for internal inspection of a web part of the wheel.

FIG. 10 shows a principle in which the ultrasonic sensor module is in close contact with a wheel surface.

FIG. 11 shows a structure of a sensor module for injecting water, which is a contact medium, between the wheel and a wedge.

FIG. 12 shows a process of performing, by the ultrasonic inspection module, ultrasonic detection and inspection.

FIG. 13 shows a state in which a wheel is inspected simultaneously in a pulse-echo (P/E) inspection method and a time of flight diffraction (TOFD) inspection method using the ultrasonic inspection module.

FIG. 14 shows a comparison of the states of inspecting the wheel using the P/E inspection method and the TOFD inspection method using the ultrasonic inspection module.

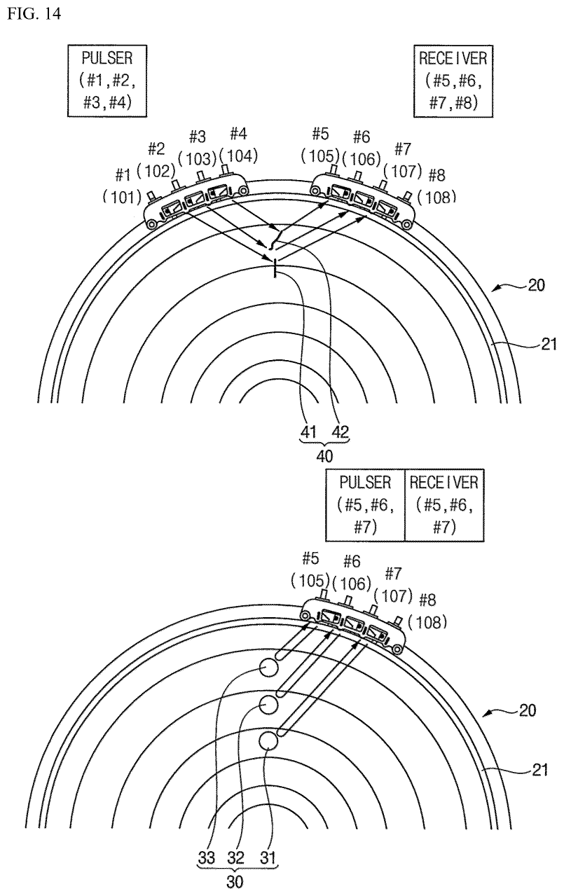

FIG. 15 shows a flowchart of an ultrasonic inspection method using the ultrasonic inspection module.

FIG. 16 shows an image showing the result of stress analysis on the web part of the wheel, and the result of selecting defect occurrence prediction areas.

FIG. 17 shows an ultrasonic beam path analysis process for determining a location and incidence angle of the wedge of the sensor module, and the location and incidence angle of the wedge of the sensor module that have been obtained as the result of the ultrasonic beam path analysis process.

FIG. 18 shows the result of the ultrasonic beam path analysis and ultrasonic signals (S-scan) for each sensor module in the P/E method.

FIG. 19 shows the result of the ultrasonic beam path analysis and an ultrasonic signal for each sensor module in the TOFD method.

FIG. 20 shows a schematic diagram of locations at which defects mainly occur in the rim part of the wheel.

FIG. 21 shows a location and angle of the wedge for each inspection area of the rim part of the wheel.

FIG. 22 shows the result of the ultrasonic beam path analysis for each sensor module in the ultrasonic inspection on the rim part of the wheel.

FIG. 23 shows the ultrasonic inspection result for each sensor module in the P/E inspection method of the ultrasonic sensor module on the rim part of the wheel.

FIG. 24 shows a state in which a laser inspection module according to one embodiment of the present invention radiates a laser beam through a light emitting part and receives the reflected beam through a light receiving part.

FIG. 25 shows a state in which an optimal inspection condition of the laser inspection module according to one embodiment of the present invention may be made through X-axis and N-axis movements.

### DETAILED DESCRIPTION OF EXEMPLARY EMBODIMENTS

Hereinafter, embodiments of the present invention will be described with reference to the accompanying drawings.

A detailed description will be made focusing on parts necessary to understand operations and actions according to the present invention.

In description of embodiments of the present invention, description of technical content that is well known in the art to which the present invention pertains and is not directly related to the present invention will be omitted.

It is to convey the present invention more clearly without obscuring the gist of the present invention by omitting unnecessary description.

In addition, in description of components of the present invention, components with the same name may be denoted by different reference numerals according to the accompanying drawings, and the components with the same name may be denoted by the same reference numerals even in different drawings.

However, even in this case, it does not mean that the corresponding components have different functions according to embodiments or have the same function in different embodiments, and the function of each component should be determined based on the description of each component in the corresponding embodiment.

In addition, technical terms used in the present specification should be construed as meanings generally understood by those skilled in the art to which the present invention pertains unless specifically defined otherwise in the present specification, and should not be construed in an excessively comprehensive sense or in an excessively reduced sense.

In addition, the singular expression used herein includes the plural expression unless the context states otherwise.

In the present application, terms such as “composed of” or “including” should not be construed as necessarily including all of various components or operations described in the specification and should be construed as not including some of the components or some of the operations or further including additional components or operations.

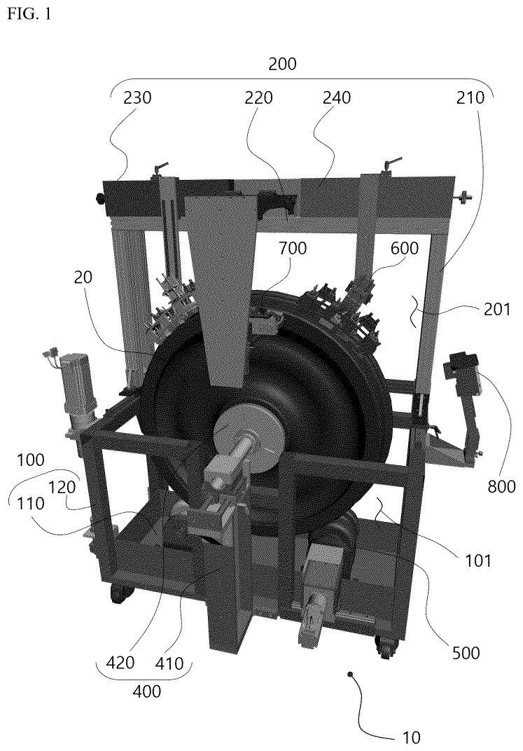

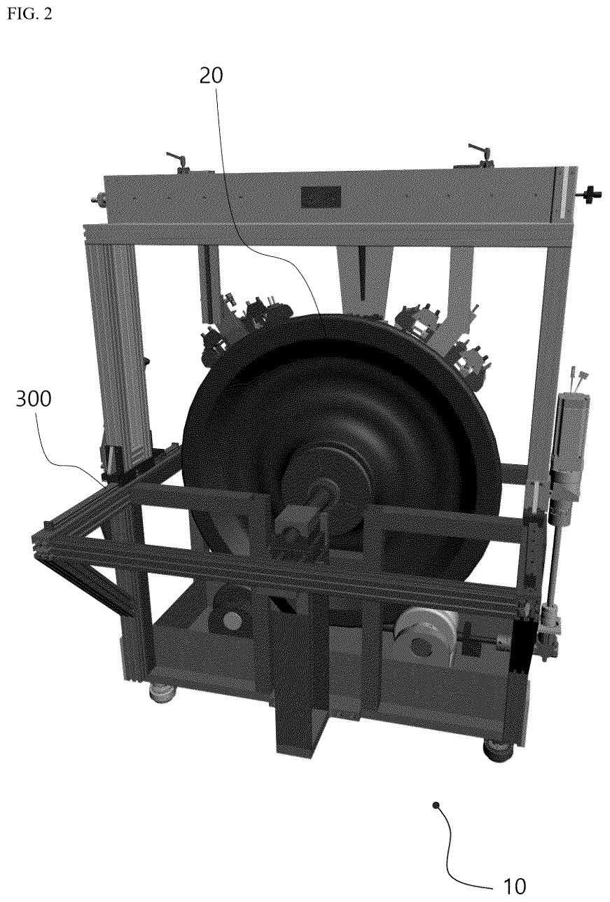

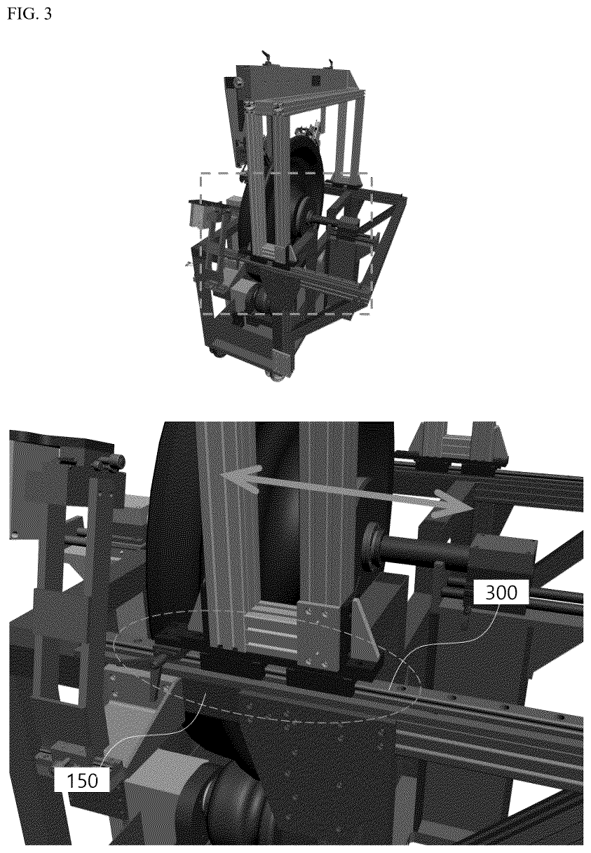

Referring to FIGS. 1 to 3, a railway vehicle wheel inspection device 10 (hereinafter referred to as an inspection device) according to the present embodiment includes a lower frame module 100, an upper frame module 200, an upper end portion moving device 300, a fixing module 400, a rotational module 500, a first inspection module 600, a second inspection module 700, and a third inspection module 800.

The lower frame module 100 constitutes a lower frame of the inspection device 10 and includes a base plate 110 located on the ground and extending in a planar shape, and a lower frame 120 formed by connecting a plurality of frames on the base plate 110.

In this case, a structure of the lower frame module 100 is only illustrative, and it is sufficient that a lower space 101 is formed to locate the fixing module 400 and the rotational module 500, which will be described below, in the lower space 101.

That is, it is shown that the lower frame 120 has the lower space 101 formed by connecting a plurality of horizontal frames and a plurality of vertical frames, but the connection relationship, arrangement relationship, etc., of the frames may be designed in various ways.

However, the lower frame module 100 should have the predetermined lower space 101 in which the fixing module 400 and the rotational module 500 are located therein, and the lower space 101 should be formed to have a predetermined height.

At an upper end of the lower frame 120, upper end portion support frames 150 having a predetermined length are each formed in parallel in an axial direction (X-axis direction or first direction) of a wheel 20 at left and right locations of the mounted wheel. The upper end portion support frame 150 is fastened to an LM guide 300, which is an upper end portion moving device having a sliding groove structure in the first direction (X-axis direction).

The upper frame module 200 constitutes an upper frame of the inspection device 10 and includes an upper vertical frame 210 placed on the upper end portion support frame 150 formed on the lower frame 120 of the lower frame module 100, fastened to the LM guide 300, and extending upward (Z-axis direction or third direction), an upper horizontal frame 220 horizontally extending in a direction (Y-axis direction or second direction) perpendicular to the upper vertical frame 210, and additional horizontal frames 230 and 240. Therefore, to mount the wheel on the inspection device, the upper frame module 200 may move to a predetermined distance in a longitudinal direction of the LM guide.

In this case, a pair of upper vertical frames 210 may extend in parallel as shown, and the upper horizontal frame 220 connects upper ends of the pair of upper vertical frames 210.

In this case, the additional horizontal frame 230 extends in a plate shape having a predetermined height on an upper surface of the upper horizontal frame 220 and is connected to the first inspection module 600 to be described below.

A bent frame 710 on which the second inspection module 700 is mounted is connected to the upper horizontal frame 220, and the bent frame 710 is connected to a central portion of the upper horizontal frame 220, and a second vertical frame 720 on which the second inspection body 760 is mounted is connected to the bent frame 710 through a hinge to rotate about an axis in the second direction (Y-axis direction). When the wheel is mounted on the inspection device 10, it is possible to secure a space, in which the wheel may be mounted, by lifting the second vertical frame 720.

As shown, the upper frame module 200 has an upper space 201 formed above the lower space 101, and the wheel 20 is located in the lower space 101 and the upper space 201.

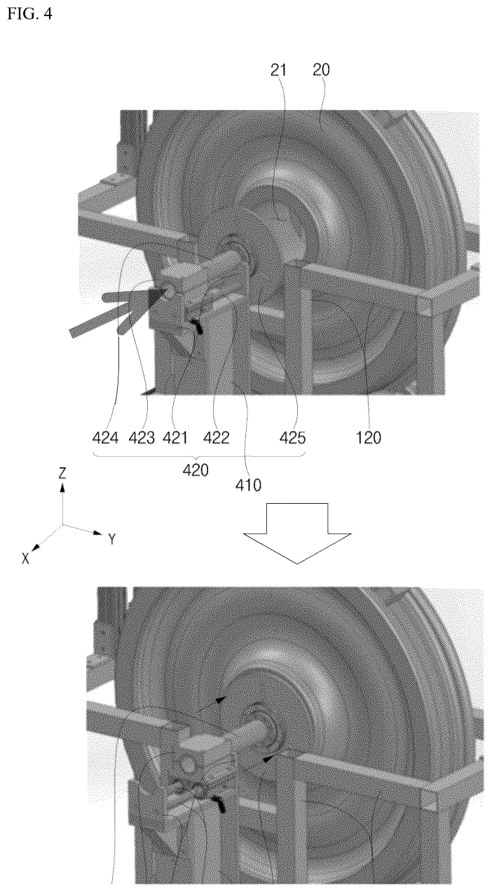

Referring to FIG. 4, the fixing module 400 includes a fixing extension frame 410 and a fixing unit 420. In this case, a pair of fixing modules 400 are provided symmetrically at front and rear sides with respect to the wheel 20 and have the same structure except that the pair of fixing modules 400 are provided symmetrically. Therefore, hereinafter, only one fixing module 400 will be described.

The fixing extension frame 410 extends to a predetermined length in the third direction (Z-axis direction) in a state of being fixed to the base plate 110, and the fixing unit 420 is fixed to an upper end of the fixing extension frame 410. That is, the fixing extension frame 410 is a frame that extends to locate the fixing unit 420 at a predetermined height.

The fixing unit 420 is fixed to the upper end of the fixing extension frame 410 to fix a central portion 25 of the wheel 20 so that the wheel 20 is located in the lower space 101 and the upper space 201.

Specifically, the fixing unit 420 includes a pair of guide plates 421 spaced a predetermined distance from each other, a bar-shaped guide bar 422 extending in the first direction (X-axis direction) between the guide plates, a guide block 423 to be transferred in the first direction (X-axis direction) along the guide bar 422, a bar-shaped extension bar 424 extending from the guide block 423 toward the wheel 20, and a fixing plate 425 having a circular plate shape connected to an end of the extension bar 424.

Thus, when the wheel 20 is located between a pair of fixing units 420, the guide block 423 is transferred along the guide bar 422 to couple the fixing plate 425 connected to the end of the extension bar 424 with the central portion 25 of the wheel 20. Therefore, the wheel 20 is fixed by the pair of fixing units 420.

In this case, the fixing plate 425 should be connected to the extension bar 424 to rotate when the wheel 20 rotates. In addition, the fixing plate 425 should have a shape that may be coupled to a shape of a flange formed on the central portion 25 of the wheel 20.

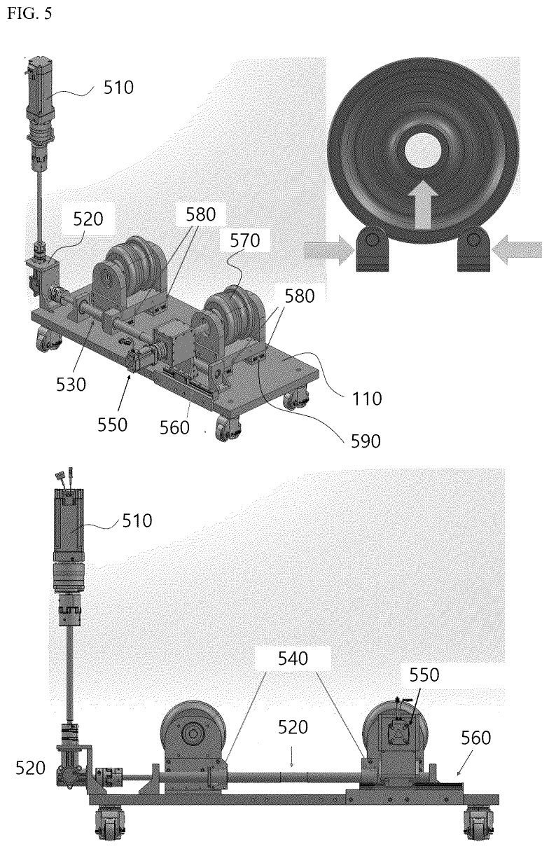

FIG. 5 shows the rotational module and a rotational module controller in detail. The rotational module 500 may be located on the base plate 110 and as shown, a pair of rotational modules 500 may be disposed to be spaced a predetermined distance from each other.

The rotational module 500 includes a roller 570 for rotating the wheel, a stage 580 for holding the roller to rotate the roller 570, and a roller driving motor 550 for rotating the roller 570 and is coupled to a transfer guide 590 by which the rotational module 500 is guided along the way of being slidably transferred in the second direction (Y-axis direction).

In addition, the rotational module 500 is fastened by being connected to a ball screw shaft, and a gearbox 520 is operated by an operation of a roller movement motor 510. When the ball screw shaft 530 connected to the gearbox 520 is rotated, the rotational module 500 is transferred by the roller transfer guide 590. At this time, the roller driving motor 550 is transferred along with the motor transfer guide 560. When the ball screw shaft 530 rotates, the ball nuts 540 provided at left and right sides of the ball screw shaft 530 should be rotated in opposite directions. Therefore, when a torque generated by the roller movement motor 510 is transmitted to the ball screw shaft 530 through the gearbox 520, the pair of rotational modules 500 are transferred in a direction close to or away from each other through the roller 570 and the transfer guide 590.

In this case, there is provided a mechanism in which the railway vehicle wheel 20 supported by the roller 570 moves upward when the rotational modules 500 move to be close to each other, and conversely, the railway vehicle wheel 20 moves downward when the rotational modules 500 move in a direction away from each other.

The pair of rotational modules 500 is transferred to be close to each other in an arrow direction in the second direction (Y-axis direction) to move the wheel 20 upward in the third direction (Z-axis direction). As described above, when the wheel 20 moves up to align the central portion 25 with the location of the fixing plate 425, the wheel 20 is fixed to the fixing module 400. Of course, to align the fixing plate 425 with the central portion 25 according to a size, that is, a radius of the wheel 20, the wheel 20 may move upward and also move downward.

The roller rotational motor 550 is located at one side of the stage 580 to provide a rotational driving force, and the rotational driving force provided by the roller rotational motor 550 is provided to the roller 570. Therefore, the roller 570 rotates about a rotational axis.

In this case, the roller 570 is in contact with the wheel 20, and as the roller 570 rotates, the wheel 20 also rotates. That is, the pair of rotational modules 500 are provided, and when the pair of rollers 570 are rotated in the same direction, for example, rotated clockwise in a state of being in contact with the wheel 20, the wheel 20 rotates counterclockwise.

In addition to rotating the wheel 20, the rotational module 500 moves the wheel 20 upward and downward through transfer in the second direction (Y-axis direction) to be fixedly located at the fixing module 400.

After the wheel 20 is fixed as described above, inspection is performed while the first and second inspection modules 600 and 700 are close to or bring into contact with the wheel 20.

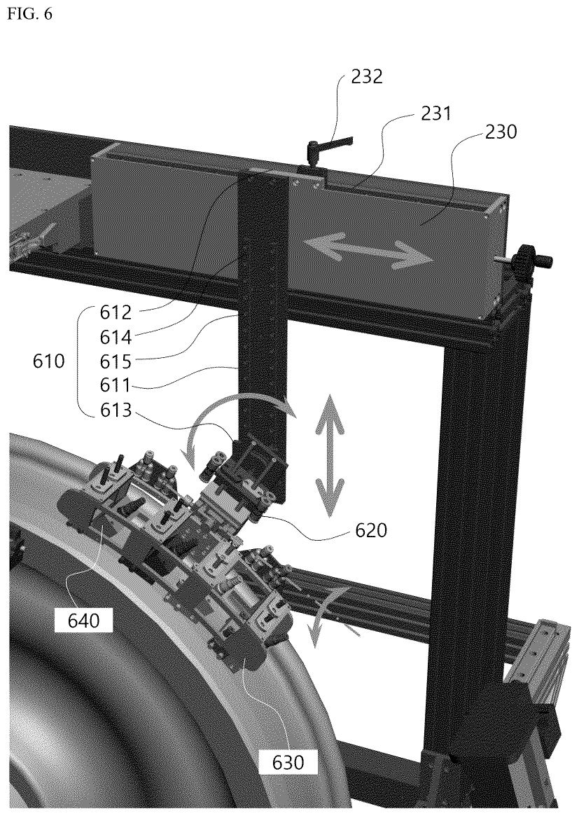

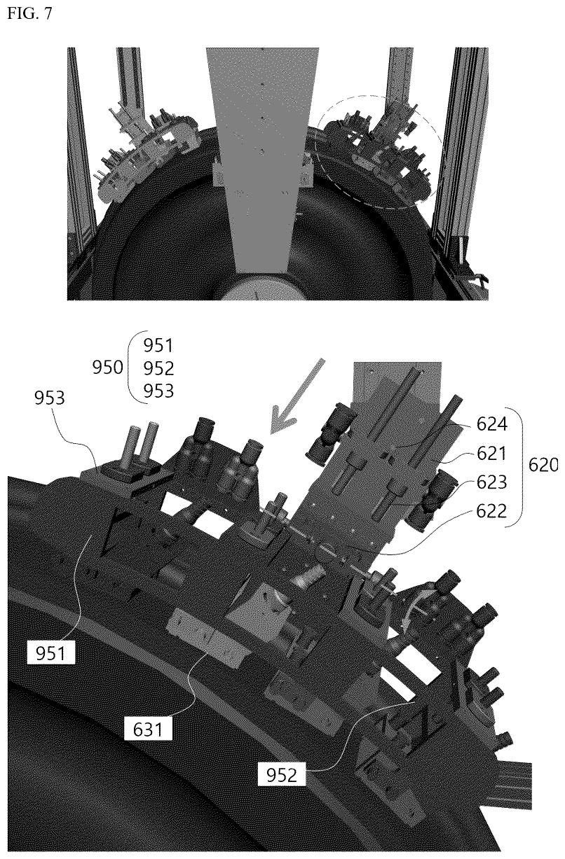

Referring to FIGS. 6 and 7, the first inspection module 600 performs defect inspection on the web part of the wheel 20 and includes a first vertical frame 610, a first rotational frame 620, a first inspection body 630, and a first inspection unit 640.

The first vertical frame 610 extends vertically in the third direction (Z-axis direction) and includes a first vertical plate 611, a transfer part 612, a first sliding plate 613, a sliding groove 614, and a fixing part 615. The first vertical plate 611 has a rectangular plate shape extending to a predetermined length in the third direction (Z-axis direction), and the transfer part 612 is formed at an upper end of the first vertical plate 611.

The transfer part 612 may be slidably coupled to a rail part 231 formed along an upper surface of the additional horizontal frame 230, and as the transfer part 612 is slidably transferred along the rail part 231, a location of the first vertical plate 611 may be changed in the second direction (Y-axis direction) and include a lever 232 capable of fixing the location of the first vertical plate 611 to prevent movement at a designated location.

Meanwhile, the first sliding plate 613 is coupled to an upper surface of the first vertical plate 611 to slide in the third direction (Z-axis direction) along the first vertical plate 611. In this case, a pair of first sliding grooves 614 may be formed in the first vertical plate 611, and thus the first sliding plate 613 may slide along the first sliding grooves 614.

In addition, a plurality of fixing parts 615 may be formed at regular distances on the first sliding grooves 614, and the fixing parts, which may be coupled or fixed to the fixing parts 615, may be formed on the sliding plate 613. Therefore, the sliding plate 613 may be fixedly located at a specific location while moving in the third direction (Z-axis direction).

Meanwhile, the first rotational frame 620 is connected to the first sliding plate 613, and the first rotational frame 620 is coupled to rotate about a rotational center axis in the first direction (X-axis direction) with respect to the sliding plate 613. Specifically, the first rotational frame 620 includes a first rotational plate 621, a tilting stage 622, a first pressing part 623, and a central part 624.

The first rotational plate 621 is rotatably connected to the sliding plate 613 through the central part 624 and rotates about the rotational center axis in the first direction (X-axis direction) with respect to the central part 624. In addition, the first rotational plate 621 may have a rectangular plate shape extending to a predetermined length, and the tilting stage 622 is connected to an end of the first rotational plate 621.

Meanwhile, the first pressing part 623 is located on the first rotational plate 621, of which one side is fixed and the other side is connected to the tilting stage 622. In this case, the first pressing part 623 may be an elastic part having a predetermined elastic force, and thus provides a predetermined pressing force to the tilting stage 622.

Therefore, the first inspection body 630 connected to the tilting stage 622 can be more stably in close contact with the web part 22 of the wheel 20.

The tilting stage 622 may have a structure in which a first pressing part connecting part (not shown) and an inspection body connecting part (not shown) are connected through a hinge and rotates the inspection body 630 about the hinge to be in contact with or separated from the rim part 23. An ultrasonic inspection module may be tilted by the tilting stage to allow the ultrasonic inspection module to be in easy contact with a tread of the rim part 23 of the wheel.

As a location or attitude of the first rotational plate 621 is changed, a location or attitude of the first inspection body 630 connected to the tilting stage 622 may be changed.

The first inspection body 630 may include a contact surface 631 entirely having the same curvature as the wheel 20 and have a curved block shape forming a predetermined internal space 632. In addition, the first inspection body 630 is connected to the tilting stage 622 and, as described above, is in close contact with the rim part 23 by the pressing force of the first pressing part 623.

The first inspection unit 640 is located in the predetermined internal space 632 formed by the first inspection body 630 to perform defect inspection on the web part 22 of the wheel 20 using ultrasonic waves. In this case, as shown, a plurality of first inspection units 640 may be arranged at regular distances to perform ultrasonic inspection on different areas in a state of being in close contact with the rim part 23, and the number of first inspection units 640 may be changed in various ways.

Meanwhile, as described above, a pair of first inspection modules 600 may be provided, and when the pair of first inspection modules 600 are provided, the first inspection modules 600 may be disposed symmetrically with respect to the wheel 20. In addition, upon performing inspection on the web part 22 of the wheel 20 through the first inspection units 640 of the pair of first inspection modules 600, there are a case of using both the pair of first inspection modules 600 and a case of selectively using only one first inspection module 600.

In addition, as described above, the location of the first vertical frame 610 may be changed in the second direction (Y-axis direction) above the additional horizontal frame 230, and the location of the first rotational frame 620 may be changed in the third direction (Z-axis direction) above the first vertical frame 610, and its attitude may change to rotate with respect to the first vertical frame 610.

Therefore, even when the location of the rim part 23 of the wheel 20, which is an object to be inspected, is changed in various ways, the first inspection module 600 may be in easy contact with the rim part 23 in any location and attitude. Therefore, defect inspection may be easily performed on the web part regardless of the size of the wheel 20.

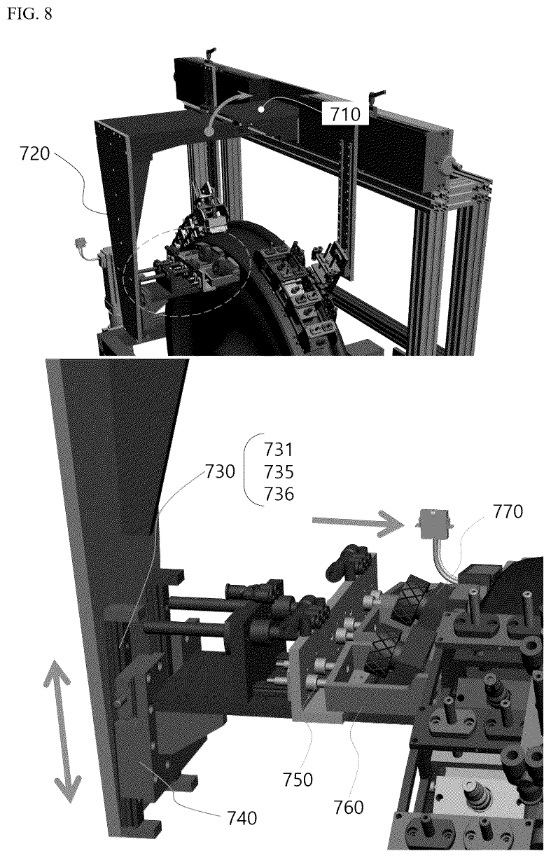

Referring to FIG. 8, the bent frame 710 including the second vertical frame 720 on which the second inspection module 700 is mounted includes a second vertical plate 730 formed to have a predetermined length in the third direction (Z-axis direction), and the second vertical plate 730 includes a second sliding groove 731 and a second fixing part 735. The second sliding plate 740 is coupled to the second vertical plate 730 to slide in the third direction (Z-axis direction) along the second vertical plate 730. In this case, since a pair of second sliding grooves 731 may be formed in the second vertical plate 730, the second sliding plate 740 may slide along the sliding grooves 731.

In addition, a plurality of second fixing parts 736 may be formed at regular distances on the second sliding grooves 731, and the fixing part 735, which may be coupled or fixed to each of the second fixing parts 736, may be formed on the second sliding plate 740. Therefore, the second sliding plate 740 may be fixedly located at a specific location while moving in the third direction (Z-axis direction).

Meanwhile, the second sliding plate 740 includes a second pressing part 750 and a second inspection body 760. In the second pressing part 750, one side is fixed to the second sliding plate 740 and the other side is connected to a second inspection body support. In this case, since the second pressing part 750 has a structure of which a length may extend in the first direction (X-axis direction), the second pressing part 750 may adjust a location of the second inspection body 760 in the first direction (X-axis direction) and may be an elastic part having a predetermined elastic force. Therefore, the second pressing part 750 provides a predetermined pressing force to the second inspection body 760.

Therefore, the location of the second inspection unit 770 may be changed in the first direction (X-axis direction) by the pressing force, and the second inspection unit 770 may be more stably in close contact with the rim part 23 of the wheel 20. As described above, since the second inspection body 760 is also formed to move by a predetermined displacement in the first direction (X-axis direction) and the third direction (Z-axis direction), the second inspection unit 770 is stably in close contact with the rim part 23 of the wheel 20 at a more accurate location to perform defect inspection. In addition, defects of the rim part of any wheel may be inspected through the second inspection module 700 regardless of the type, size, etc., of the wheel 20.

According to the embodiments of the present invention, it is possible to separately perform defect inspection on the web part 22 and the rim part 23 of the wheel through a separate inspection module, thereby performing more reliable inspection and evaluation in various states of the wheel. In this case, by designing an attitude, location, and moving range of each inspection module to allow the inspection module to accurately inspect the web part 22 and the rim part 23 of the wheel, it is possible to more accurately inspect any size of a wheel.

In addition, the first inspection module can be designed so that the first inspection unit provided at the end thereof moves horizontally and vertically and rotates in consideration of the curvature changed according to the size of the wheel, and thus can be more accurately seated on the web part 22 of the wheel in various attitudes. Likewise, the second inspection module can also be designed so that the second inspection unit provided at the end thereof moves horizontally and vertically, and thus can be more accurately seated on the rim part 23 of the wheel. In particular, since both the first and second inspection modules include the pressing part using the elastic force for stable contact and seating of the first and second inspection units, it is possible to improve the accuracy and reliability of inspection.

As the size of the wheel is changed, the rotational module is designed to rotate and move upward to move the wheel up to any location, and the upper frame module 200 may be moved to mount the wheel on the inspection device, and a space in which the wheel may be mounted can be secured by lifting the second vertical frame 720 of the bent frame on which the second inspection body 760 is mounted. Therefore, the wheel can be more easily mounted and detached.

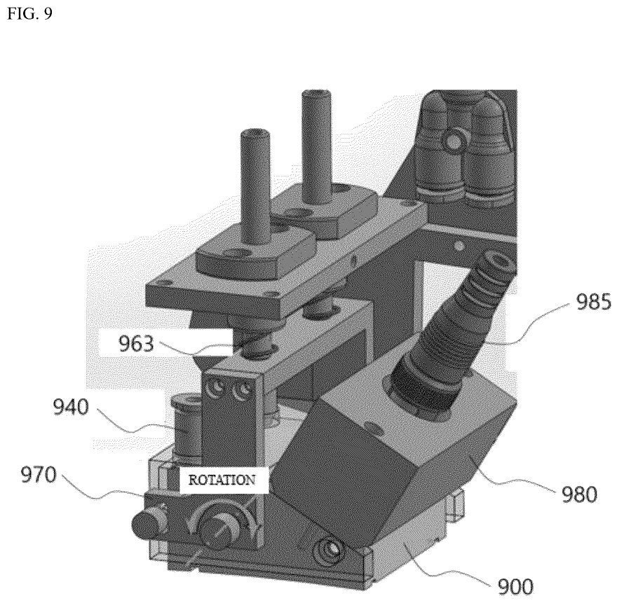

FIG. 9 shows a configuration of the sensor module, and the ultrasonic inspection module for internal inspection of the web part is composed of four sensor modules. The sensor module generally includes a wedge part 900 coupled to an ultrasonic probe, an ultrasonic probe jig 980 in contact with the wedge part 900, a spring 963, a joint 940, a sensor module jig 970, a BNC 985, etc., and four sensor modules are simultaneously in contact with the wheel to perform inspection.

The ultrasonic sensor module may be moved in a normal direction of a tread portion of the wheel, which is a contact surface, by the spring and may receive a force in the normal direction to allow ultrasonic waves to be easily transmitted in the wheel. In addition, the sensor module may be designed to enable rotational motion so that the tread surface of the rim part of the wheel comes in easy contact with the wedge part. The joint 940 is coupled to the wedge part 900 to supply a contact medium between the tread surface of the wheel 20 and the wedge part 900.

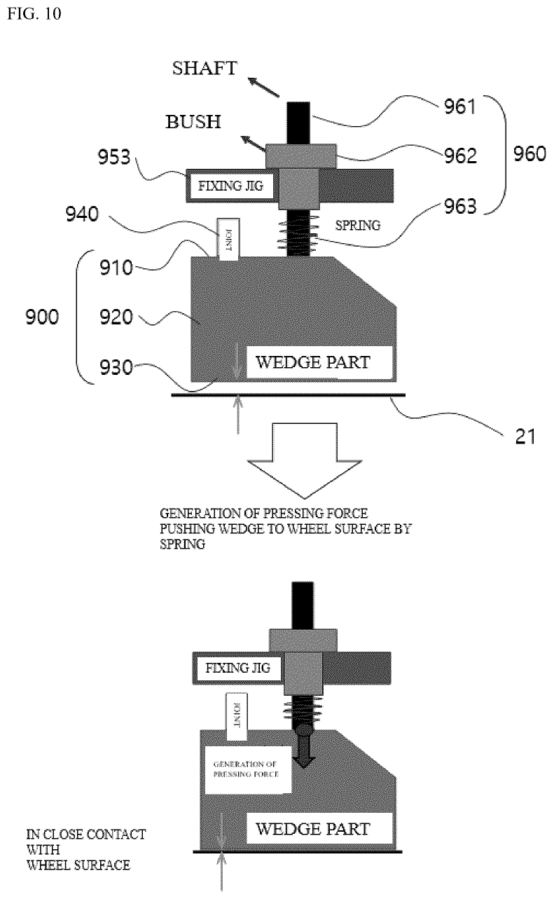

Referring to FIG. 10, the ultrasonic inspection module according to the present embodiment includes a frame part 950 and a plurality of sensor modules 922, 923, 924, and 925. The frame part 950 includes a pair of first and second side frames 951 and 952 extending in parallel at both sides, and a fixing jig 953 forming an upper surface thereof. The sensor modules 922, 923, 924, and 925 are located in an internal region formed by the frame part 950.

In this case, in the present embodiment, although it is shown that a total of four sensor modules are located in a row in the internal space of the frame part 950, one or more sensor modules are sufficient, and the number thereof is not limited. However, hereinafter, for convenience of description, four sensor modules are shown, and each of the sensor modules has the same structure and shape.

The sensor module includes the wedge part 900, a plunger part 960, and a water provision part 990. The wedge part 900 generates ultrasonic waves, and an ultrasonic probe (not shown) is located therein to transmit or receive the ultrasonic waves. In this case, since an ultrasonic generation and reception mechanism is the related art, detailed description thereof will be omitted. Although the wedge part 900 may have an overall quadrangular block shape and one corner of the quadrangular block is formed to be inclined, a shape thereof is not limited.

Specifically, the wedge part 900 includes an upper surface portion 910, a body portion 920, and a lower surface portion 930. The upper surface portion 910 forms an upper surface of the wedge part 900, and the lower surface portion 930 forms a lower surface of the wedge part 900. In this case, the plunger part 960 is coupled to the upper surface portion 910, and the lower surface portion 930 is a surface in close contact with the tread 21 of the wheel.

The body portion 920 forms a body of the wedge part 900 and has a predetermined internal space 921 formed therein. In this case, the ultrasonic probe (not shown) may be located in the internal space. The plunger part 960 includes a shaft 961 and the fixing jig 953 and presses the wedge part 900 downward through the shaft 961 and the fixing jig 953 to allow the wedge part 900 to be in close contact with the wheel 20. Specifically, the fixing jig 953 has a plate shape extending in the horizontal direction and is located to be spaced a predetermined height from the upper surface portion 910 of the wedge part 900.

The fixing jig 953 is fixedly located on the pair of first and second side frames 951 and 952, and a location of the fixing jig 953 maintains in a fixed state. The shaft 961 extends downward to pass through the fixing jig 953 to which a bush is fastened, and the spring 963 is located at a lower end of the shaft 961.

The spring 963 has an upper end connected to the bush 962 and a lower end in close contact with the upper surface portion 910 and extends in a vertical direction that is an extension direction of the shaft 961. The wedge part 900 is pressed downward by the spring 963, and in this case, the spring 963 may be a spring having a predetermined coefficient of elasticity.

Therefore, the wedge part 900 is pressed by the pressing of the spring 963 to push the wedge part 900 downward. Therefore, the lower surface portion 930 of the wedge part 900 located with a predetermined distance to the tread 21 is in close contact with the tread 21 by the pressing.

In a condition in which no external force is applied, the wedge part 900 is fixed on the fixing jig 953 through the plunger part 960, and the lower surface portion 930 of the wedge part 900 is designed to be spaced a predetermined distance from the tread 21. Therefore, when the ultrasonic inspection device 10 moves to an inspection location on the tread 21 of the wheel, it is possible to prevent movement interference or damage to the wedge due to contact between the lower surface portion 930 of the wedge part 900 and the tread 21.

However, after the ultrasonic inspection device 10 moves to the inspection location, the lower surface portion 930 of the wedge part 900 should be in close contact with the tread 21 to allow the ultrasonic waves generated from the wedge part 900 to be effectively provided to the rim part or the web part of the wheel 20 through the tread 21. When the external force is applied to the plunger part 960, the lower surface portion 930 of the wedge part 900 is in close contact with the tread 21 by the pressing of the plunger part 960.

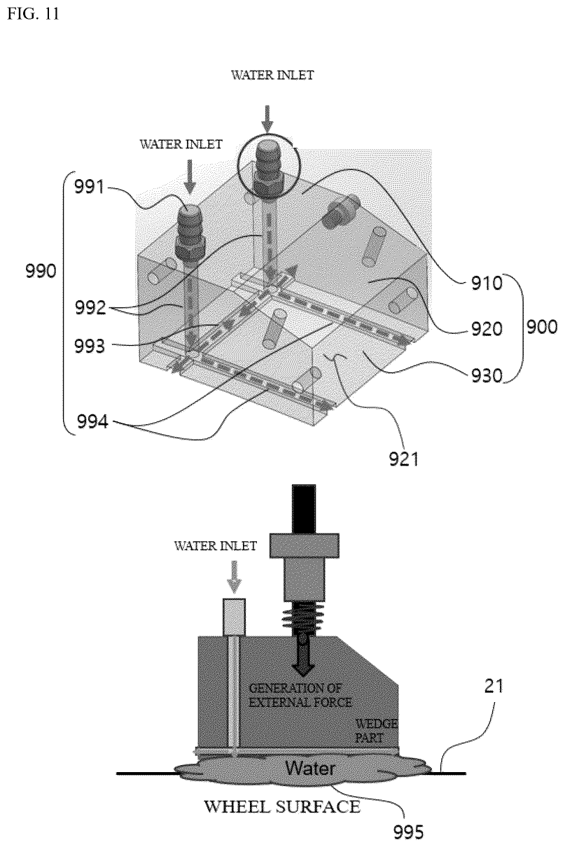

Referring to FIG. 11, the water provision part 990 provides water to form a water film between the lower surface portion 930 and the tread 21 when the lower surface portion 930 is in close contact with the tread 21. The water provision part 990 includes an inlet 991, a downward flow path 992, a first lower flow path 993, and a second lower flow path 994.

The inlet 991 extends to pass through the upper surface portion 910 of the wedge part 900 and is connected to an external water provision unit to receive water from the outside. In this case, a pair of inlets 991 may be formed to be spaced apart from each other on the upper surface portion 910, and the number or location thereof may be designed in various ways.

The downward flow path 992 is connected to the inlet 991 and extends downward to pass through the internal space 921 of the body portion 920 to supply the introduced water downward. In this case, although it is shown in FIG. 4A that the downward flow path 992 extends vertically downward, an extension direction of the downward flow path 992 may be changed in design in various ways, and it is sufficient that the introduced water is supplied downward.

The first and second lower flow paths 993 and 994 are connected to the downward flow path 992 and formed along the lower surface portion 930. In this case, although it is shown in the drawing that the first lower flow path 993 and the second lower flow path 994 extend in directions perpendicular to each other and are formed along the lower surface portion 930, the extension directions of the lower flow paths may also be changed in various ways. That is, the first and second lower flow paths 993 and 994 may be formed to extend in any of various directions from the lower surface portion 930, and thus it is sufficient that water flows between the lower surface portion 930 and the tread 21.

As described above, when water is provided between the lower surface portion 930 and the tread 21 through the first and second lower flow paths 993 and 994, a water film 995 is formed, and the water film 995 allows the wedge part 900 to be in easy contact with the surface of the wheel and increases ultrasonic beam transmissibility. Therefore, the ultrasonic waves generated from the wedge part 900 can be more effectively transferred to the tread 21. Meanwhile, the water provision part 990 should continuously supply water during the ultrasonic inspection process to allow the water film 995 to be stably formed in the ultrasonic inspection process.

According to the embodiments of the present invention, since the sensor module for generating ultrasonic waves is more in close contact with the tread and the water film is formed between the sensor module and the tread, it is possible to more effectively induce the transmission and reception of an ultrasonic signal, thereby increasing the accuracy of the defect inspection on the rim part or the web part of the wheel.

In particular, the ultrasonic precision inspection module moves on the tread of the wheel for inspection, and the sensor module and the tread may be spaced apart from each other in the moving process and the sensor module is in close contact with the tread only in the case of performing defect detection, thereby increasing the ease of movement to an arbitrary location and the accuracy of the defect detection. In this case, the sensor module includes the plunger part for pressing the wedge part for generating ultrasonic waves by receiving an external force, and the plunger part may press the wedge part through an elastic pressing force, thereby increasing the contact with the tread.

In addition, since water introduced from the outside is provided to the tread along the lower flow path formed on the lower surface portion of the wedge part through the wedge part, water may be effectively supplied between the tread and the wedge part to effectively transmit the ultrasonic signal by the water film. Furthermore, since defect evaluation on the rim part and the web part of the wheel may be performed through one ultrasonic precision inspection module, more reliable inspection and evaluation can be performed on any state of the wheel.

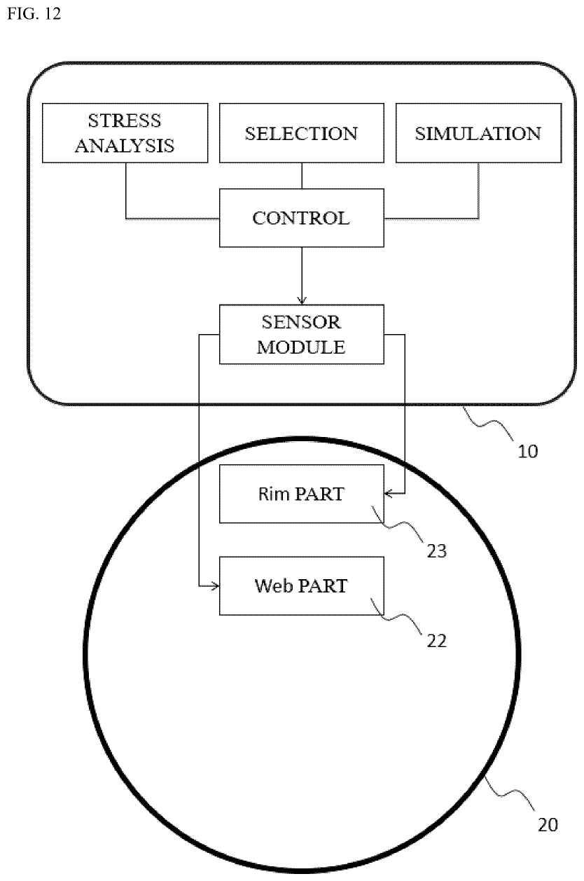

Referring to FIG. 12, the ultrasonic inspection process of the present invention includes a process of operating the sensor module through processes of stress analysis, selection, simulation, and a controller. The sensor module generates and acquires an ultrasonic signal for performing defect inspection on the rim part 23 and the web part 22 and based on the same, determines whether defects are present.

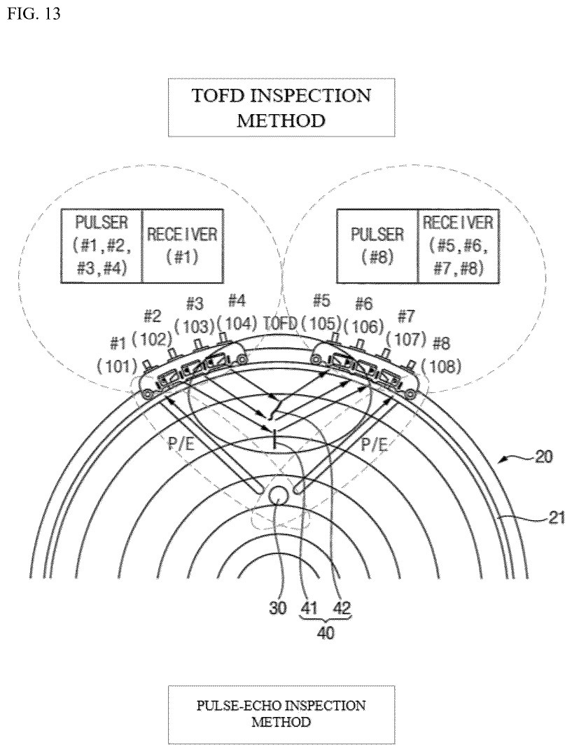

FIG. 13 is a schematic diagram showing a state of performing defect inspection on a rim part and a web part using an ultrasonic inspection module. Referring to FIG. 13, a pair of ultrasonic inspection modules 10 and 11 according to the present embodiment are located on the wheel 20 of a railway vehicle to detect defects 30 and 40 of the web part of the wheel 20.

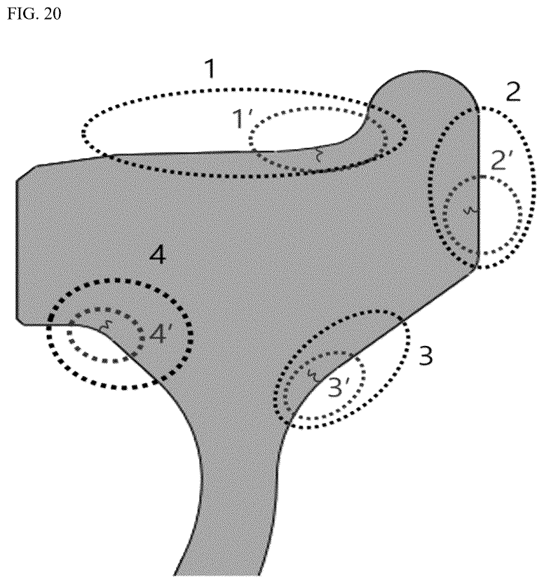

In general, the rim part 23 of the wheel refers to an outer circumferential portion of the wheel 20 including the tread 21 and a flange in which the wheel is in contact with a rail, and the ultrasonic inspection module in the present embodiment detects defects of the rim part of FIG. 20 using a pulse-echo (P/E) inspection method.

In contrast, the web part 22 of the wheel is a web connecting the tread 21 with a hub, and the ultrasonic inspection module in the present embodiment detects the defect 40 of the web part using the P/E inspection method or a time of flight diffraction (TOFD) inspection method. However, to omit overlapping description of the P/E inspection method and the TOFD inspection method, hereinafter, an example in which the P/E inspection method is used for performing defect inspection on the rim part, and the TOFD inspection method is used for performing defect inspection on the web part will be exemplarily described.

Meanwhile, the P/E inspection method is an inspection method of performing inspection by allowing one sensor module to serve as a pulser and a receiver, and the TOFD inspection method is an inspection method of performing inspection by allowing one of the pair of sensor modules to serve as a pulser and the other to serve as a receiver. Therefore, in a case in which the pair of ultrasonic inspection modules 10 and 11 are symmetrical, the first ultrasonic inspection module is located at one side of the wheel 20, and the second ultrasonic inspection module is located at the other side of the wheel 20, the P/E inspection method and the TOFD inspection method are both applicable.

That is, when the first ultrasonic inspection module 10 includes first to fourth sensor modules and the second ultrasonic inspection module includes fifth to eighth sensor modules, the defects of the rim part of FIG. 20 may be detected through the P/E inspection method, and the defects 30 and 40 of the web part may be detected through the P/E inspection method or the TOFD inspection method.

For example, in the P/E inspection method, since one sensor module should serve as both the pulser and the receiver, the first sensor module 101 (#1) of the first ultrasonic inspection module may serve as the pulser and the receiver with respect to the defects 30 and 40 of the web part, and likewise, the eighth sensor module 108 (#8) of the second ultrasonic inspection module may serve as the pulser and the receiver with respect to the defects 30 and 40 of the web part.

Alternatively, in the TOFD inspection method, since the sensor module used as the pulser differs from the sensor module used as the receiver, the second to fourth sensor modules 102, 103, and 104 (#2, #3, and #4) of the first ultrasonic inspection module may serve as the pulser with respect to the defects 30 and 40 of the web part, and the fifth to seventh sensor modules 105, 106, and 107 (#5, #6, and #7) of the second ultrasonic inspection module may serve as the receiver with respect to the defects 30 and 40 of the web part.

Of course, it is apparent that a combination of the sensor module used in the P/E inspection method or the sensor module used in the TOFD inspection method may be changed differently, but may be selected to enable an optimal combination of the pulser and the receiver in consideration of the locations or number of defects 30 and 40 of the web part.

As described above, by arranging the pair of ultrasonic inspection modules including at least one sensor module on the wheel 20, ultrasonic defect detection may be performed on defects of the rim part and the web part through the P/E inspection method and the TOFD inspection method.

However, to use the TOFD inspection method, as described above, the ultrasonic inspection module serving as the pulser of ultrasonic waves and the ultrasonic inspection module located at a location at which ultrasonic waves which are the transmitted ultrasonic waves reflected from defects are received should be provided as a pair. As described above, since the inspection method may be selectively used, inspection according to any shape or structure of a wheel is possible.

When defects included in the wheel 20 include the defects 30 and 40 of the web part, defect inspection on the defects 30 and 40 of the web part may be performed by the P/E inspection method or the TOFD inspection method through the ultrasonic inspection module.

For example, in the case of using the TOFD inspection method, the first to fourth sensor modules 101, 102, 103, and 104 (#1, #2, #3, and #4) of the first ultrasonic inspection module may serve as the pulser with respect to the defects 30 and 40 of the web part, and the fifth to eighth sensor modules 105, 106, 107, and 108 (#5, #6, #7, and #8) of the second ultrasonic inspection module may serve as the receiver with respect to the defects 30 and 40 of the web part.

Alternatively, the defects 30 and 40 of the web part included in the wheel 20 may also be detected through the P/E inspection method. In this case, in the case of the P/E inspection method, since inspection is possible through one ultrasonic inspection module, the first to fourth sensor modules 101, 102, 103, and 104 (#1, #2, #3, and #4) may each serve as the pulsar and the receiver with respect to the defects 30 and 40 of the web part.

Of course, in the case of applying the P/E inspection method, inspection may be performed by arranging only one ultrasonic inspection module as shown in FIG. 4B, and inspection may be performed by driving only any one of the inspection modules in a state in which a pair of ultrasonic inspection modules are disposed.

As described above, defects may be detected by selected one or both of the P/E inspection method and the TOFD inspection method in a state in which one ultrasonic inspection module or a pair of ultrasonic inspection modules of the present embodiment are disposed in consideration of the types, occurrence states, etc., of the defects 30 and 40 of the web part included in the wheel 20. Therefore, regardless of the type of defect, any defect detection method may be applied more easily and conveniently without setting or moving a separate ultrasonic inspection module.

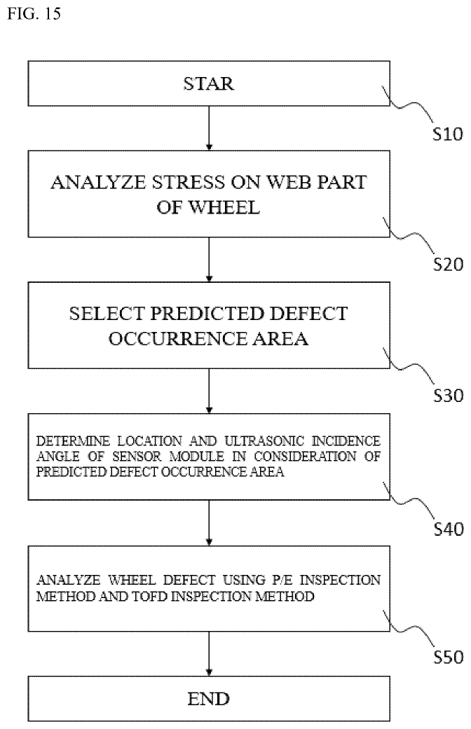

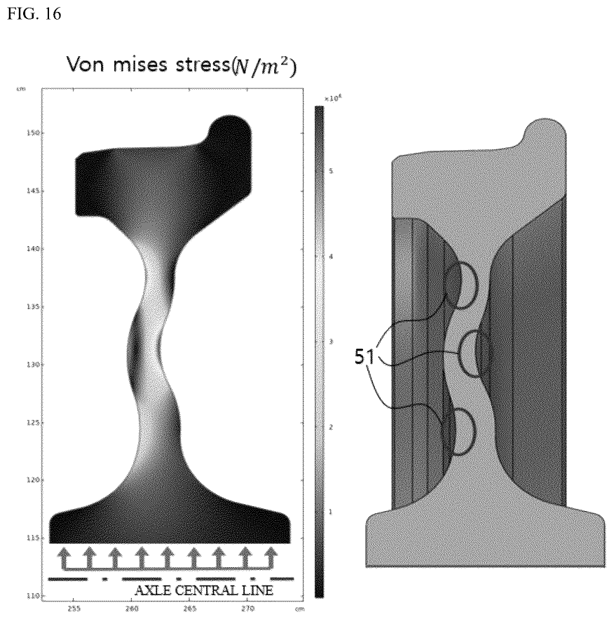

Referring to FIGS. 15 and 16, in the ultrasonic inspection method using the ultrasonic inspection module according to the present embodiment, first, before defect inspection is directly performed, stress on the web part 22 of the wheel 20 is analyzed. In this case, in the present embodiment, although an example in which stress only on the web part 22 of the wheel 20 is analyzed is shown, the stress analysis may be performed on both the web part and the rim part. However, hereinafter, for convenience of description, the result of the stress analysis on the web part will be described as an example of a defect.

Such stress analysis may be performed through simulation, and FIG. 16 is an example of the result of performing finite elements method (FEM) simulation. That is, as shown in FIG. 16, for example, by setting a weight along an axle center line with respect to a wheel of a railway vehicle having a predetermined radius, stress distribution occurring in the web part 22 of the wheel of the railway vehicle may be derived in advance through simulation. Then, referring to FIGS. 15 and 16, a predicted area in which defect occurrence is predicted is selected based on the stress analysis result.

That is, based on the result of simulating the stress distribution in FIG. 16A, as shown in FIG. 16B, a predicted area 51 in which defects of the wheel occur in the future may be selected as an area in which stress is concentrated. In this case, the predicted area 51 in which the defects of the wheel occur may be selected as a plurality of areas. In addition, criteria for determining whether an area in which stress is concentrated is present may be set in advance, and the set criteria may be changed in various ways.

As described above, by setting the predicted area in which the defects of the wheel occur as the area in which stress is concentrated in advance, based on the same, the location of the ultrasonic inspection module may be set in advance, thereby minimizing the time and cost of the defect detection compared to detecting defects by inspecting all areas. In this case, the area in which defect occurrence is predicted may be the rim part or the web part.

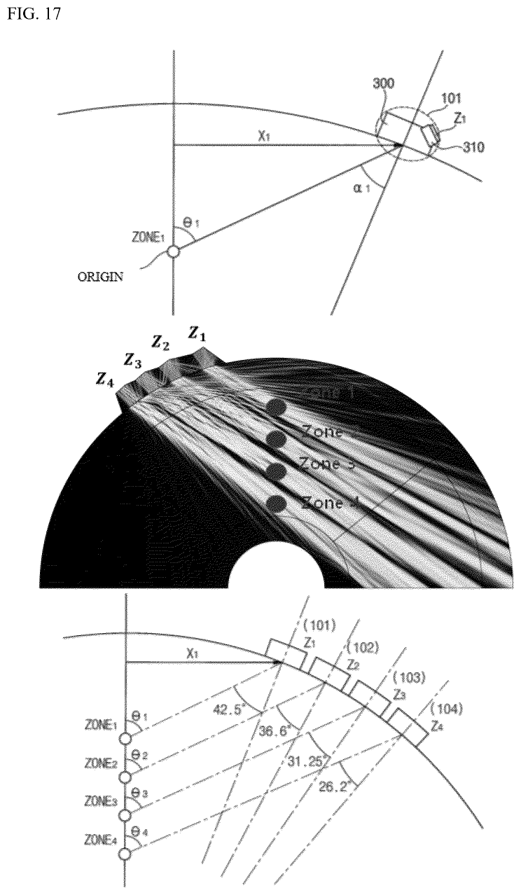

The locations and ultrasonic incidence angles of the sensor modules are set in the ultrasonic inspection module 10 in consideration of the predicted defect occurrence area 51. That is, when the ultrasonic inspection module 10 includes at least one sensor module, the location and ultrasonic incidence angle of each sensor module are set to locate the sensor module at the corresponding location. For example, as shown in FIG. 17A, when the predicted defect occurrence area ZONE₁ is set, the location of the sensor module may be set with respect to the area ZONE₁.

The location of the sensor module is set in consideration of a location of an ultrasonic probe (not shown) located inside the wedge part 900 to generate ultrasonic waves, that is, in consideration of incidence angles of the ultrasonic waves provided to the inside of the wheel 20. That is, the location of the sensor module should be set to allow the ultrasonic waves provided to the inside of the wheel 20 to reach the predicted defect occurrence area ZONE₁, and likewise, the incidence angles of the ultrasonic waves should also be set.

That is, the location of the sensor module may be set at an angle θ₁ that is tilted with respect to a line segment passing through the central axis of the wheel 20 through the area ZONE₁ and with respect to a distance X1 spaced apart from the area ZONE₁ in a horizontal direction, and a location (origin) of the area ZONE₁.

In addition, when the sensor module is set to be located at the corresponding location, the wedge part 900 included in the sensor module may be located in contact with the tread 21 of the wheel 20, and thus an angle di formed between the wedge part 900 and the area ZONE₁ may be set. Therefore, the incidence angles of the ultrasonic waves entering the wheel 20 through the sensor module are also set.

As described above, the location and ultrasonic incidence angle of the sensor module may be determined in consideration of the predicted defect occurrence area, and for example, when four predicted defect occurrence areas ZONE₁ to ZONE₄ are present, a location and incidence angle of each of a total of four sensor modules 101, 102, 103, and 140 (Z₁, Z₂, Z₃, and Z₄) may also be set.

The ultrasonic waves provided to the predicted defect occurrence areas by the locations and ultrasonic incidence angles of the sensor modules set as described above are shown in FIG. 17B. In addition, an example of the actual arrangement of the four sensor modules whose locations and incidence angles are set to provide ultrasonic waves to the predicted areas is shown in FIG. 17C.

In this case, the predicted defect occurrence areas ZONE₁ to ZONE₄ may be the defects 30 and 40 of the web part, and the type of defect is not distinguished. It is because, as described above, the ultrasonic inspection module according to the present embodiment may use both the P/E inspection method and the TOFD inspection method and selectively adopt a sensor module that is 6 optimal for adopting the corresponding inspection method according to the type and location of defect.

TABLE 1
Information about ultrasonic inspection module
when the P/E inspection method is applied

| De- | | | | |
|---|---|---|---|---|
| fect | Zone 1 | Zone 2 | Zone 3 | Zone 4 |
| α | α₁ = 42.5° | α₂ = 36.6° | α₃ = 31.25° | α₄ = 26.2° |
| X | X₁ = 168 mm | X₂ = 224 mm | X₃ = 264 mm | X₄ = 319 mm |
| θ | θ₁ = 21° | θ₂ = 28° | θ₃ = 33° | θ₄ = 39° |

| | |
|---|---|
| f | 2.25 MHz, 5 MHz |

More specifically, the locations and ultrasonic incidence angles of the sensor modules disposed in FIG. 17C are shown in Table 1. In this case, when the P/E inspection method is applied to the predicted defect occurrence areas ZONE₁ to ZONE₄, one ultrasonic inspection module 10 is used as described above, and the location and ultrasonic incidence angle of each sensor module when the one ultrasonic inspection module 10 is used are shown in Table 1.

In this case, the ultrasonic inspection module 10 may include the first to fourth sensor modules 101, 102, 103, and 104. Therefore, α₁, α₂, α₃, and α₄ are angles formed between the wedge parts of the first to fourth sensor modules and the areas ZONE₁, ZONE₂, ZONE₃, and ZONE₄, respectively, X1, X2, X3, and X4 are distances by which the wedge parts of the first to fourth sensor modules are horizontally spaced apart from the areas ZONE₁, ZONE₂, ZONE₃, and ZONE₄, respectively, and θ₁, θ₂, θ₃, and θ₄ are angles at which the wedge parts of the first to fourth sensor modules are tilted with respect to the locations (origins) of the areas ZONE₁, ZONE₂, ZONE₃, and ZONE₄, respectively. Meanwhile, f denotes a frequency of the ultrasonic probe.

That is, the P/E inspection method may be applied based on the locations and ultrasonic incidence angles of the sensor modules set through Table 1 as described above, and thus defects of the wheel of a railway vehicle can be effectively detected.

On the other hand, when the TOFD inspection method is applied to the predicted defect occurrence areas ZONE₁ to ZONE₄, the pair of ultrasonic inspection modules are used as described above, and the location and ultrasonic incidence angle of each sensor module when the pair of ultrasonic inspection modules are used are shown in Table 2.

TABLE 2
Information about ultrasonic inspection module
when the TOFD inspection method is applied

| De- | | | | |
|---|---|---|---|---|
| fect | Zone 1 | Zone 2 | Zone 3 | Zone 4 |
| α | α₁ = 42.5° | α₂ = 36.6° | α₃ = 31.25° | α₄ = 26.2° |
| X | X₁ = 168 mm | X₂ = 224 mm | X₃ = 264 mm | X₄ = 319 mm |
| θ | θ₁ = 21° | θ₂ = 28° | θ₃ = 33° | θ₄ = 39° |

| | |
|---|---|
| f | 2.25 MHz, 5 MHz |

In this case, Table 2 shows the locations and ultrasonic incidence angles of the sensor modules of the one ultrasonic inspection module shown in FIG. 8, and it is sufficient that the locations and ultrasonic incidence angles of the sensor modules of the other ultrasonic inspection module are symmetrical with the locations and incidence angles shown in Table 2 below with respect to the central axis passing through the areas ZONE₁, ZONE₂, ZONE₃, and ZONE₄.

In this case, the case where α₁, α₂, α₃, and α₄ are angles formed between the wedge parts of the first to fourth sensor modules and the areas ZONE₁, ZONE₂, ZONE₃, and ZONE₄, respectively, X1, X2, X3, and X4 are distances by which the wedge parts of the first to fourth sensor modules are horizontally spaced apart from the areas ZONE₁, ZONE₂, ZONE₃, and ZONE₄, respectively, θ₁, θ₂, θ₃, and θ₄ are angles at which the wedge parts of the first to fourth sensor modules are tilted with respect to the locations (origins) of the areas ZONE₁, ZONE₂, ZONE₃, and ZONE₄, respectively, and f denotes the frequency of the ultrasonic probe is the same as in Table 1.

That is, since the TOFD inspection method may be applied based on the locations and ultrasonic incidence angles of the sensor modules set through Table 2 as described above, defects of the wheel of the railway vehicle can be effectively detected.

As described above, after eventually setting the location of the ultrasonic inspection module in consideration of the predicted defect occurrence area, the defects on the wheel 20 are analyzed by the P/E inspection method or the TOFD inspection method.

In this case, the P/E inspection method or the TOFD inspection method may be applied to the defect analysis on the wheel 20 according to the type of defect of the wheel 20, and as described above, the P/E inspection method may be applied to the defects of the rim part in FIG. 20, and the P/E inspection method or the TOFD inspection method may be applied to the defects 30 and 40 of the web part.

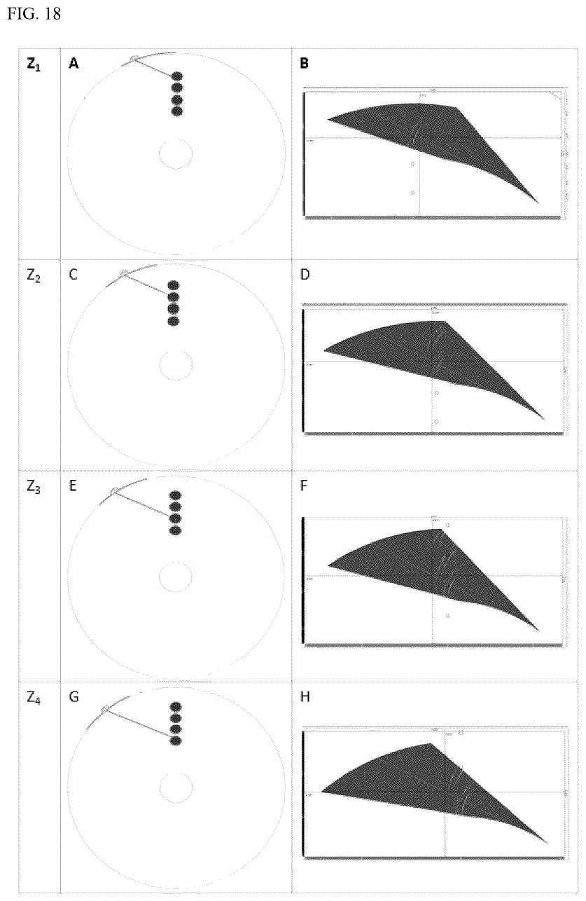

The following description will be made by replacing actual inspection results with simulation results. FIG. 18 shows the FEM simulation result for each sensor module in the case of the P/E method. FIGS. 18A, 18C, 18E, and 18G show paths of ultrasonic beams propagated into the wheel, hitting defects, and scattering, and FIGS. 18B, 18D, 18F, and 18H show ultrasonic signals (S-scan) within the range of a specific angle. In this case, since the ultrasonic beam generated by the ultrasonic probe propagates as a spherical wave rather than a plane wave, reflected waves reflected by hitting defects propagate back to the sensor module.

Shown are images showing paths of ultrasonic beams in the case of providing ultrasonic waves to the predicted defect occurrence area through the P/E inspection method at the set location of the ultrasonic inspection module 10 with respect to the four areas ZONE₁ to ZONE₄ previously selected as the predicted defect occurrence area.

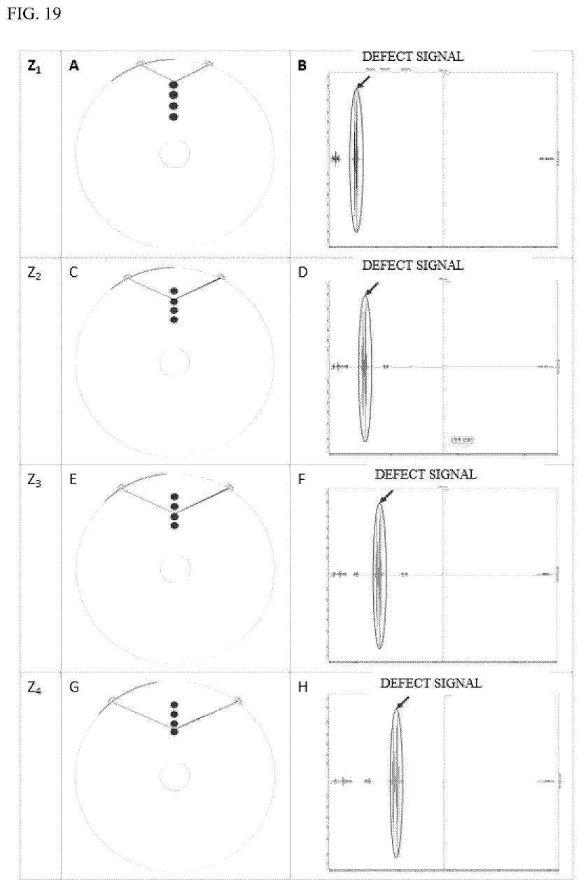

FIG. 19 shows the FEM simulation result for each sensor module in the case of the TOFD method. FIGS. 19A, 19C, 19E, and 19G show paths of ultrasonic beams propagated into the wheel and scattered after hitting defects, and FIGS. 19B, 19D, 19F, and 19H show defect signals (A-scan) acquired by a receiver. In this case, in the TOFD method, defect signal acquisition is possible only when the receiver is present at a point corresponding to the same reflective angle as the incidence angle.

In the case of the TOFD inspection method, as shown in FIGS. 11A to 11D, it can be seen that the ultrasonic waves generated through each of the sensor modules 101, 102, 103, and 104 propagate into the wheel 20, hit the defects each of ZONE₁, ZONE₂, ZONE₃, and ZONE₄, and scatter. In this case, the other sensor modules 105, 106, 107, and 108 receiving the ultrasonic waves should be located at points corresponding to the same reflective angles as the incidence angles of transmitted ultrasonic waves of the sensor modules 101, 102, 103, and 104 transmitting the ultrasonic waves.

As described above, the sensor modules 101, 102, 103, and 104 transmit the ultrasonic waves to the defects ZONE₁, ZONE₂, ZONE₃, and ZONE₄, respectively, and the other sensor modules 105, 106, 107, and 108 receive reflective waves reflected from the defects ZONE₁, ZONE₂, ZONE₃, and ZONE₄, respectively. Therefore, the defects 30 and 40 of the web part are detected by the TOFD inspection method.

FIG. 20 schematically shows main defect occurrence locations 1, 2, 3, and 4 of a rim part of a wheel of a railway vehicle and shows selected inspection areas 1′, 2′, 3′, and 4′ to be subjected to defect inspection using the device of the present invention. Like the ultrasonic inspection of the web part, three wedges were used in the ultrasonic precision defect detection sensor module for inspecting the corresponding area of the rim part, and angles of the wedges were calculated.

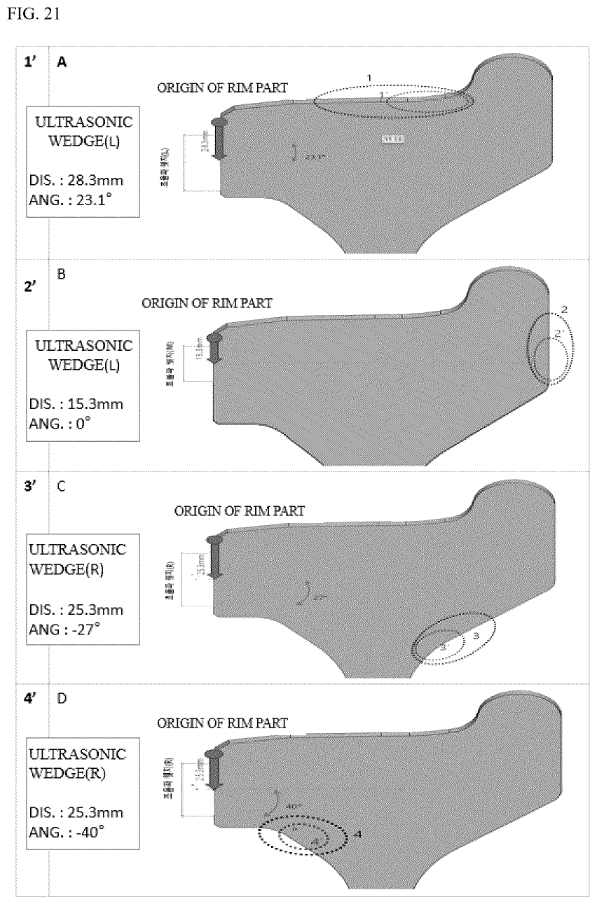

FIG. 21 shows locations and set angles of the wedges with respect to inspection areas of a rim part of a wheel, and frequencies (f) of an ultrasonic probe used in the same manner as the ultrasonic inspection of the web part are 2.25 MHz and 5 MHz. A location of the wedge performing defect inspection on the inspection area 1′ is spaced 28.3 mm from the origin of the rim part and an incidence angle of the wedge is 23.1°, a location of the wedge performing defect inspection on the inspection area 2′ is spaced 15.3 mm from the origin of the rim part and an incidence angle of the wedge is 0° (perpendicular incidence), and locations of the wedges performing defect inspection on the inspection areas 3′ are spaced 25.3 mm from the origin of the rim part and incidence angles of the wedges are −27° and −40°.

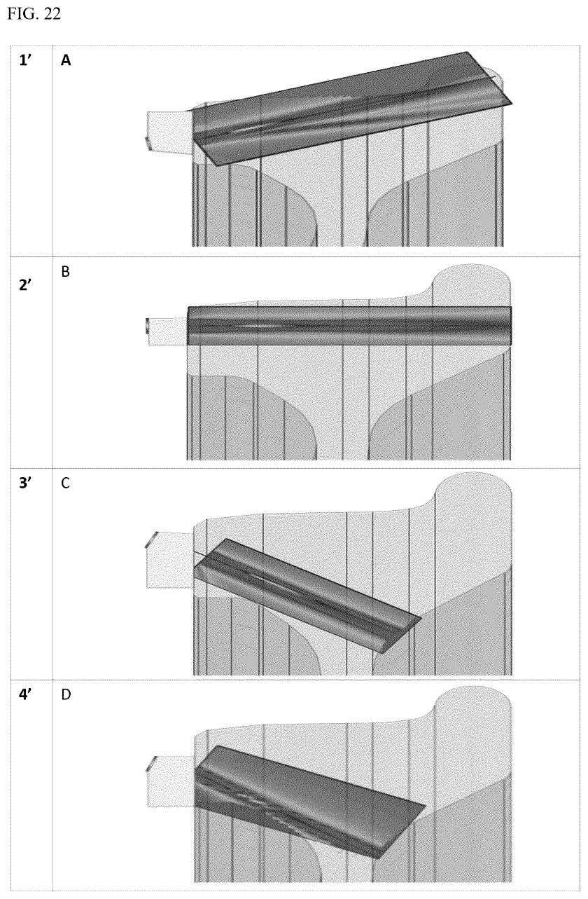

FIG. 22 shows an ultrasonic beam path analysis result using FEM simulation with respect to each sensor module of a rim part using a wedge and shows the ultrasonic beam path analysis result performing using the location and incidence angle of the wedge to be mounted on the module selected in FIG. 16, and it can be seen that inspection areas are sufficiently included. In addition, the ultrasonic precision defect inspection sensor module for inspecting the rim part performed inspection using the P/E method.

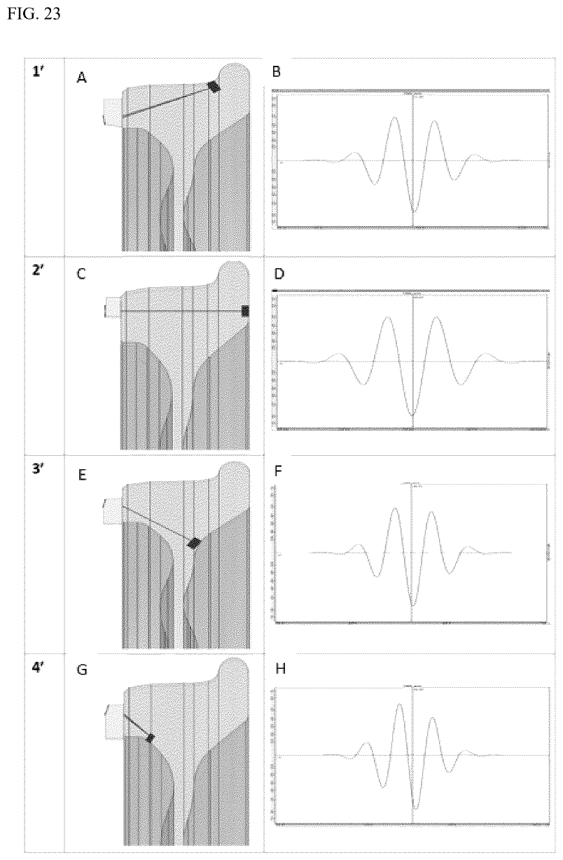

FIG. 23 shows an ultrasonic inspection experimental result using wedge parameters of a sensor module of a rim part in a railway vehicle selected previously and FEM simulation. FIG. 23 shows each ultrasonic experimental result using the sensor module of the rim part in the railway vehicle when defects are present in the previously selected inspection areas 1′, 2′, 3′, and 4′, and it can be seen that inspection is possible.

As described above, detection may be performed by transmitting or receiving ultrasonic waves based on whether the location of the defect is a defect of the rim part or a defect of the web part. In addition, when it is unclear whether the location of the corresponding defect is the defect of the rim part or the defect of the web part, corresponding results may be reviewed by applying the P/E inspection method to the defect of the rim part and applying the P/E inspection method or the TOFD inspection method to the defect of the web part.

According to the embodiments of the present invention, since defect evaluation on the rim part and the web part of the wheel may be performed through one ultrasonic precision inspection module, more reliable inspection and evaluation can be performed on any state of the wheel.

In particular, when the one ultrasonic inspection module includes a plurality of sensor modules, the sensor modules may each be used as one of a pulser and a receiver in the defect inspection at the plurality of locations using the P/E inspection method, and thus defect inspection at any location is possible.

Meanwhile, in the case of using the TOFD inspection method, in a state in which the pair of ultrasonic inspection modules are located at locations corresponding to the incidence angle and reflective angle of the ultrasonic wave, a plurality of sensor modules included in any one ultrasonic inspection module are used as pulsers, and a plurality of sensor modules included in the other ultrasonic inspection module are used as receivers. Therefore, defect inspection at various locations may also be performed.

In addition, since an ultrasonic inspection method using the ultrasonic inspection module includes primarily selecting the area in which stress is concentrated as the predicted defect occurrence area through stress analysis and determining the locations and ultrasonic incidence angles of the sensor modules in consideration of the predicted area, it is possible to reduce a trial and error and minimize time and cost, thereby accurately and quickly detecting defect occurrence.

In this case, in each case of using the P/E inspection method or the TOFD inspection method as the detection method, by optimally arranging the sensor modules in consideration of the reception location of the reflected ultrasonic signal, it is possible to identify any defect, in particular, the defects of the rim part and the web part of the wheel and acquire results with one inspection, thereby increasing the speed, convenience, and accuracy of defect inspection.

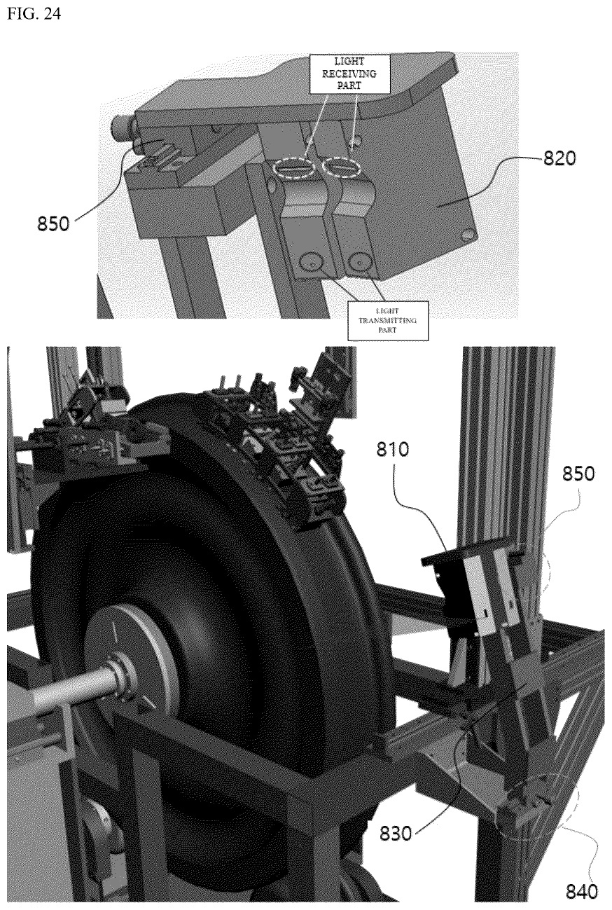

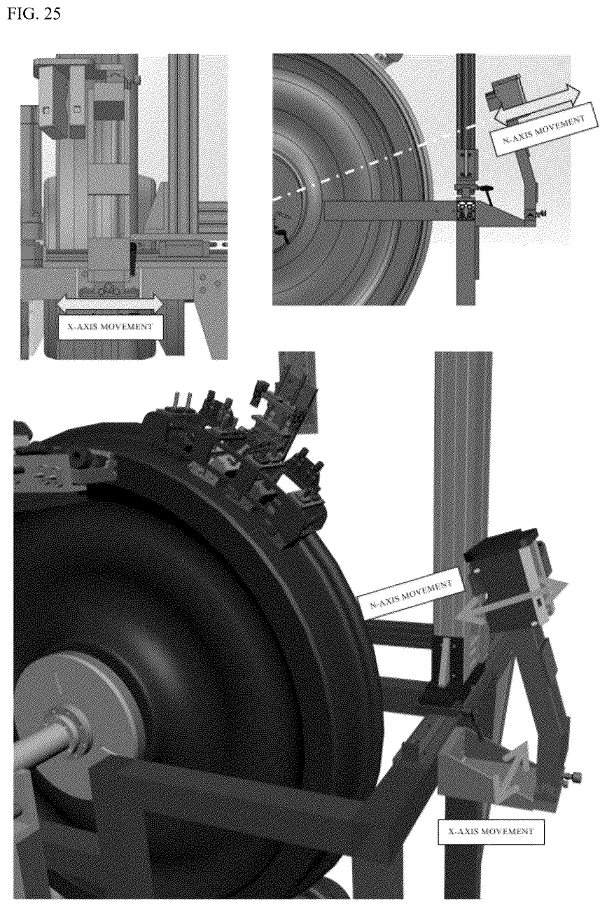

A laser inspection module 800 for performing defect inspection on a tread surface of the rim part of the wheel is shown in FIGS. 24 and 25. A laser inspection body 810 composed of two laser sensors 820 is mounted on a laser inspection module holder 830 adjacent to the wheel at one side of the upper end portion support frame 150 and installed at a location at which a laser beam is projected onto the rim part 23 of the wheel and receives the laser emitted from a light transmitting part in a light receiving part.

The laser inspection module holder 830 includes a first stage 840 for allowing the laser inspection body 810 to slidably reciprocate in an axial direction of the wheel 20, which is the first direction (X-axis direction), and a second stage 850 for allowing the laser inspection body 810 to slidably reciprocate in a fourth direction (N-axis direction) linearly connecting the laser inspection module with the central axis of the wheel.

FIG. 24 shows a state in which inspection of the surface of the rim part 23 of the wheel is performed with the beam of the laser sensor. The laser emitted from the laser sensor is emitted in a triangular shape as it moves away from the laser sensor, and it can be seen that when the laser reaches a specific distance, widths of the laser beams cover the entirety of the tread surface of the rim part 23 of the wheel.

In addition, the laser should be designed to be incident in the N-axis direction of the tread surface at all times to maintain the constant reproducibility of an inspection result. The laser beam reaching the surface of each wheel 20 is reflected from the surface of the wheel 20 and reaches the light receiving part, and thus a profile of the surface of the rim part of the wheel may be acquired. That is, to secure the reproducibility of inspection for the acquisition of the profile of the surface of the rim part 23, the laser inspection module holder 830 should be provided with the laser inspection body 810 at a predetermined angle to allow the laser beam to be radiated to transmit the center of the wheel 20 and be incident in the normal direction of the rim part 23.

FIG. 25 shows movement axes due to two stages. An N-axis is in a direction passing through the center of the wheel, and an X-axis is in a direction perpendicular to the surface of the rim part 23 of the wheel. The second stage 850 in the N-axis direction serves to adjust an inspection range of a wheel surface by changing a distance between the laser sensor and the wheel surface, and the first stage 840 in the X-axis direction serves to move the inspection range of the wheel surface.

A railway vehicle wheel precision inspection device of embodiments according to the technical spirit of the present invention can distinguishably perform defect inspection on a web part and a rim part of a wheel through a separate inspection module, thereby performing more reliable inspection and evaluation on any state of a wheel. In this case, by designing an attitude, location, and moving range of each inspection module to allow the inspection module to accurately inspect the web part and the rim part of the wheel, it is possible to more accurately inspect any size of a wheel.

In particular, as the size of the wheel is changed, it is possible to rotate the wheel using a rotational module by moving the wheel up to any location and move the location of the wheel up and down. When the wheel is mounted on the inspect device, an upper frame module can be moved horizontally to secure a required space, and then the wheel can be mounted and moved back to an original location. Therefore, the wheel can be more easily mounted and detached.

In addition, a first inspection module for defect inspection using ultrasonic waves can be designed so that a first inspection unit provided at an end thereof moves horizontally and vertically and rotates in consideration of a curvature changed according to a size of the wheel, and thus can be more accurately seated on the web part of the wheel in any attitude. Likewise, a second inspection module for defect inspection using ultrasonic waves can be designed so that a second inspection unit provided at an end thereof moves horizontally and vertically, and thus can be more accurately seated on the rim part of the wheel. In particular, since both the first and second inspection modules include a pressing part using an elastic force for stable contact and seating of the first and second inspection units, it is possible to improve the accuracy and reliability of inspection.

Since a third inspection module for defect inspection using a laser can also be designed to enable horizontal location movement and distance adjustment to the wheel, it is possible to secure the reproducibility and reliability of inspection.

It should be understood that the effects of the present invention are not limited to the above-described effects and include all effects that will be inferred from the configuration of the invention described in the detailed description or claims of the present invention.

The present disclosure presents the best mode of the present invention, and embodiments for describing the present invention and allowing those skilled in the art to produce and use the present invention are provided. The disclosure of the present invention does not limit to presented specific terms.

Therefore, although the present invention has been described in detail with reference to the above embodiments, those skilled in the art can remodel, change, and modify the present embodiments without departing from the scope of the present invention. In summary, it should be noted that it is not necessary to separately include all functional blocks shown in the accompanying drawings or follow all orders shown in the accompanying drawings to achieve the intended effects of the present invention, and even when it is not the case, it may fall within the technical scope of the present invention described in the appended claims.

What is claimed is:

1. A railway vehicle wheel precision inspection device comprising:
a lower frame module forming a lower space;
an upper frame module coupled to the lower frame module and forming an upper space;
a fixing module fixed to the lower frame module and fixing a wheel;
rotational modules disposed on left and right side portions of the fixing module to rotate the wheel;
a first inspection module fixed to the upper frame module and configured to perform defect inspection on a web part of the wheel;
a second inspection module fixed to the upper frame module and configured to perform defect inspection on a rim part of the wheel; and
a third inspection module fixed to the lower frame module and configured to perform defect inspection on a surface of the rim part of the wheel in contact with a rail.

2. The railway vehicle wheel precision inspection device of claim 1, further comprising an LM guide on an upper end of the lower frame module to move the upper frame module in a first direction (X),
wherein a mounting space is secured by moving the upper frame module in the first direction (X), and then the wheel is fixed to the fixing module.

3. The railway vehicle wheel precision inspection device of claim 1, wherein the first and second inspection modules are connected to the upper frame module, and locations of the first and second inspection modules change according to a size of the wheel.

4. The railway vehicle wheel precision inspection device of claim 3, wherein the upper frame module includes:
an upper horizontal frame extending in a horizontal direction;
an additional horizontal frame which is fixed to an upper surface of the upper horizontal frame and on which the first inspection module is located by moving along a rail part in the horizontal direction; and
a bent frame which is located on a central portion of the upper horizontal frame and on which the second inspection module is located by moving along a sliding groove in a vertical direction.

5. The railway vehicle wheel precision inspection device of claim 1, wherein the fixing module includes:
a fixing unit including a pair of fixing plates coupled to a central portion of the wheel and configured to fix the central portion of the wheel such that the wheel is located in the lower space and the upper space; and
a fixing extension frame configured to locate the fixing unit at a predetermined height at which the wheel is located.

6. The railway vehicle wheel precision inspection device of claim 1, wherein each of the pair of rotational modules includes:
a roller in contact with the rim part of the wheel to rotate or support the wheel;
a roller driving motor configured to provide a rotational driving force to the roller;
a stage configured to hold the roller so that the roller rotates; and
a transfer guide along which the stage moves in one direction.

7. The railway vehicle wheel precision inspection device of claim 6, wherein the rotational module further includes:
a roller movement motor;
a ball screw shaft rotated by the roller movement motor; and
a pair of ball nuts rotated in opposite directions when the ball screw shaft rotates to transfer a pair of stages in the opposite directions, and
the pair of rotational modules are transferred in a direction close to or away from each other by the rotation of the pair of ball nuts not only to rotate the wheel but also to move the wheel upward or downward to be fixedly located at the fixing module.

8. The railway vehicle wheel precision inspection device of claim 1, wherein at least one first inspection module is in contact with the rim part of the wheel to perform the defect inspection on the web part using ultrasonic waves.

9. The railway vehicle wheel precision inspection device of claim 8, wherein one first inspection module performs the defect inspection using a pulse-echo inspection method when performing the defect inspection on the web part, and
the pair of first inspection modules perform the defect inspection using a time of flight diffraction (TOFD) inspection method when performing the defect inspection on the web part.

10. The railway vehicle wheel precision inspection device of claim 9, wherein, when the pulse-echo inspection method is used,
an ultrasonic inspection module includes a plurality of sensor modules disposed adjacent to each other on a tread of the wheel, and one of the sensor modules is used as a pulser configured to generate ultrasonic waves and a receiver configured to receive ultrasonic waves reflected from a defect.

11. The railway vehicle wheel precision inspection device of claim 9, wherein, when the TOFD inspection method is used,
a pair of ultrasonic inspection modules are disposed to be spaced a predetermined distance from each other on a tread, a pair of sensor modules are disposed, any one of the pair of sensor modules is used as a pulser configured to generate ultrasonic waves, and the other is used as a receiver configured to receive ultrasonic waves reflected from a defect.

12. The railway vehicle wheel precision inspection device of claim 8, wherein the first inspection module includes:
a first inspection body in contact with the rim part of the wheel and having a contact surface with the same curvature as the wheel; and
a first inspection unit provided as a plurality of first inspection units arranged in the first inspection body to provide ultrasonic waves to the web part.

13. The railway vehicle wheel precision inspection device of claim 12, wherein the first inspection module further includes:
a first vertical frame extending in a vertical direction so that a wedge comes in easy contact with the wheel;
a first rotational frame having an end connected to the first inspection body and rotating about the first vertical frame to extend so that the first inspection body comes into contact with the rim part of the wheel; and
a tilting stage configured to rotate the first inspection body about a hinge.

14. The railway vehicle wheel precision inspection device of claim 13, wherein the first vertical frame includes a sliding groove and a fixing part formed in the sliding groove so that the first rotational frame is fixed above the sliding groove to vertically change a location thereof, and
the first rotational frame includes a first pressing part having a predetermined elastic force and provides an external force for bringing the first inspection body into contact with the rim part of the wheel.

15. The railway vehicle wheel precision inspection device of claim 1, wherein the second inspection module includes a plurality of sensor modules disposed adjacent to each other on a tread of the wheel and performs defect inspection on the rim part of the wheel using a pulse-echo inspection method in which one of the sensor modules is used as a pulser configured to generate ultrasonic waves and a receiver configured to receive ultrasonic waves reflected from a defect.

16. The railway vehicle wheel precision inspection device of claim 15, wherein the second inspection module includes:
a second vertical frame extending in a vertical direction;
a second sliding plate extending toward the rim part of the wheel in a direction perpendicular to the second vertical frame;
a second inspection body attached to an end of the second sliding plate; and
a second inspection unit provided as a plurality of second inspection units arranged in the second inspection body to provide ultrasonic waves to the rim part.

17. The railway vehicle wheel precision inspection device of claim 16, wherein the second sliding plate includes a second pressing part having a predetermined elastic force and provides an external force for bringing the second inspection body into contact with the rim part of the wheel.

18. The railway vehicle wheel precision inspection device of claim 15, wherein, in an ultrasonic precision inspection module including a sensor module configured to perform defect inspection on the rim part or the web part of the wheel, the sensor module includes:
a wedge part configured to generate ultrasonic waves;
a plunger part configured to press the wedge part to a tread above the wedge part; and
a water provision part configured to provide water to the tread of the wheel through the wedge part.

19. The railway vehicle wheel precision inspection device of claim 18, wherein the plunger part includes:
a fixing jig to which a bush located above the wedge part is fastened;
a shaft in close contact with the wedge part through the fixing jig to which the bush is fastened; and
a spring surrounding a lower end of the shaft between the bush and the wedge part to press an upper portion of the wedge part with an elastic force.

20. The railway vehicle wheel precision inspection device of claim 18, wherein water provided to a lower flow path through the water provision part forms a water film between a lower surface portion of the wedge part and the tread of the wheel, and
the ultrasonic precision inspection module uses water as an ultrasonic contact medium so that the wedge part comes in easy contact with a surface of the wheel and ultrasonic beam transmissibility increases.

21. A railway vehicle wheel precision inspection device to which an ultrasonic inspection method using an ultrasonic inspection module is applied, wherein the ultrasonic inspection method using an ultrasonic inspection module includes:
analyzing stress on a wheel;
selecting a predicted defect occurrence area based on a result of the stress analysis;
determining a location and ultrasonic incidence angle of the sensor module in consideration of the selected predicted defect occurrence area; and
analyzing a defect of the wheel using a pulse-echo inspection method or a time of flight diffraction (TOFD) inspection method.

22. The railway vehicle wheel precision inspection device of claim 21, wherein the analyzing of the stress in a web part of the wheel includes:
setting a weight on an axial center line of the wheel and deriving stress distribution occurring in the web part of the wheel; and
selecting an area in which stress is concentrated as the predicted defect occurrence area of the web part of the wheel based on a result of the stress distribution.

23. The railway vehicle wheel precision inspection device of claim 21, wherein the determining of the location and ultrasonic incidence angle of the sensor module includes, to allow ultrasonic waves to pass through the predicted defect occurrence area, setting:
a location on a tread of the sensor module;
an incidence angle of the ultrasonic waves; and
a frequency of the ultrasonic waves.

24. The railway vehicle wheel precision inspection device of claim 23, wherein a total of four areas in which defect occurrences of the web part of the wheel are predicted are selected,
sensor modules configured to provide ultrasonic waves to each area are, with respect to a separation distance (X) from each area in a horizontal direction, a tilted angle (θ) with respect to a location of each area, and an angle (α) formed between a wedge part and each area, set according to conditions below:
first sensor module: X=168 mm, θ=21°, α=42.5°;
second sensor module: X=224 mm, θ=28°, α=36.6°;
third sensor module: X=264 mm, θ=33°, α=31.25°; and
fourth sensor module: X=319 mm, θ=39°, α=26.2°, and
the conditions are applied to the ultrasonic inspection method of the web part of the wheel.

25. The railway vehicle wheel precision inspection device of claim 21, wherein a total of four inspection areas (1′, 2′, 3′, 4′) in which defect occurrences are predicted in the analyzing of the stress on a rim part of the wheel are selected,
a total of three wedges providing ultrasonic waves to each area are, with respect to an inspection area, a distance downward in a third direction (Z) from an origin of the rim part to be located, and an incidence angle of a wedge, set according to conditions below:
ultrasonic wedge (left): inspection area 1′, separation distance=28.3 mm, and incidence angle=23.1° (transverse wave upward);
ultrasonic wedge (center): inspection area 2′, separation distance=15.3 mm, and incidence angle=0° (longitudinal wave perpendicular); and
ultrasonic wedge (right): inspection areas 3′ and 4′, separation distances=15.3 mm, and incidence angles=27° (transverse wave downward) and 40° (longitudinal wave downward), and
the conditions are applied to the ultrasonic inspection method of the rim part of the wheel.

26. The railway vehicle wheel precision inspection device of claim 1, wherein the third inspection module performs defect inspection on a tread surface of the rim part, which is a part of the wheel of a railway vehicle in contact with a rail after mounting a laser inspection module on a laser inspection module holder installed at a location at which a laser beam is radiated toward the wheel and composed of a plurality of laser sensors to receive a laser emitted from a light transmitting part in the laser sensor in a light receiving part at one side of a frame supporting an upper end portion of the lower frame module.

27. The railway vehicle wheel precision inspection device of claim 26, wherein the laser inspection module holder includes:
a first stage along which the laser inspection module slides in a first direction (X); and
a second stage along which the laser inspection module slides in a fourth direction (N-axis) linearly connecting the laser inspection module with a central axis of the wheel, and
the first stage serves to move in an inspection range of a wheel surface, and the second stage serves to adjust the inspection range of the wheel surface by changing a distance between the laser sensor and the wheel surface.

28. The railway vehicle wheel precision inspection device of claim 27, wherein the laser inspection module acquires a profile of a surface of the rim part of the wheel by receiving reflected laser in the light receiving part when the laser radiated from the light transmitting part of the laser sensor is reflected from the wheel surface, and
the laser inspection module holder allows the laser inspection module to be mounted at a predetermined angle so that a laser beam is radiated to pass through a center of the wheel and incident in a normal direction of the rim part in order to secure reproducibility of inspection on acquisition of the profile of the surface of the rim part.
